(19) United States
(12) Patent Application Publication
(10) Pub. No.: US 2012/0170656 A1
(43) Pub. Date: Jul. 5, 2012

(54) IMAGE PROCESSING APPARATUS AND IMAGE PROCESSING METHOD

(75) Inventors: Satoshi NUMATA, Tokyo (JP); Takashi OGASAWARA, Kanagawa (JP); Junichi AOKI, Tokyo (JP)

(73) Assignee: Sony Corporation, Tokyo (JP)

(21) Appl. No.: 13/309,774

(22) Filed: Dec. 2, 2011

(30) Foreign Application Priority Data
Jan. 5, 2011 (JP) 2011-000802

(51) Int. Cl. H04N 7/26

(52) U.S. Cl. 375/240.16; 375/E07.125

(57) ABSTRACT

An image processing apparatus includes: an image processing section adapted to calculate a motion vector of an image signal between a plurality of frames; a first control section adapted to programmably control the image processing section to execute motion detection; and a second control section adapted to control the first image processing section in a processing state determined in advance to execute motion detection.

### BACKGROUND

The technology disclosed herein relates to an image processing apparatus and an image processing method wherein a correlation of an image signal between a plurality of frames is detected to detect a motion vector between the frames.

A block matching technique of determining a motion vector between two screen images from image information itself has been used for a long period of time. Development of the block matching has proceeded mainly in connection with pan-tilt detection or image pickup object tracking of a television camera, video coding of the MPEG (Moving Picture Experts Group) system and so forth. Further, in the nineties, the block matching technique was applied to various applications such as sensorless camera shake correction and noise reduction (hereinafter referred to as NR) upon low illuminance image pickup by superposition of images.

The block matching is a method of calculating a motion vector between two screen images including a reference screen image which is a noticed screen image and a screen image on which a motion of the reference screen image is based (the latter screen image is hereinafter referred to as target screen image). Upon calculation of a motion vector between two screen images, the motion vector is calculated by calculating a correlation between the reference screen image and the target screen image in regard to a block of a rectangular region of a predetermined size. Two cases are available including a case in which the target screen image precedes in time to the reference screen image as in the case of motion detection according to the MPEG system and another case in which the reference screen image precedes in time to the target screen image as in the case of, for example, noise reduction by superposition of image frames hereinafter described.

It is to be noted that the term screen image used herein signifies an image formed from image data of one frame or one field and displayed as one image on a display apparatus. However, for the convenience of description herein, a screen image is sometimes referred to as frame assuming that the screen image is formed from one frame. For example, a reference screen image is sometimes referred to as reference frame and a target screen image is sometimes referred to as target frame.

In the block matching method, a target frame is divided into a plurality of target blocks, and for each of the target blocks, a search range is set to a reference frame. Then, a target block of the target frame and a reference block within a search range of the reference frame are read out from an image memory, and a SAD value is calculated for each pixel to form a SAD value table of an extent of the search range. The SAD (Sum of Absolute Difference) value is a sum of absolute difference values. Then, a minimum value of the SAD value is determined as a motion vector regarding the target block.

Japanese Patent Laid-Open No. 2009-81596 (hereinafter referred to as Patent Document 1) describes an example of processing for detecting a motion vector.

### SUMMARY

A block matching processing circuit consumes a large number of hardware resources, and various proposals have been made for a method of reducing such resources. On the other hand, the block matching process requires much time and determines the throughput of the entire circuit. Therefore, the resources and the processing time always have a trade-off relationship, and the balance between them is not determined uniquely.

For example, if a matching process based on a hierarchical structure is taken as an example, then a number of variations equal to the number of hierarchical layers like two hierarchical layers for an image of the VGA (640×480) or the like or three hierarchical layers for an image of the 12M (4,000×3,000) are required.

Further, generally an application which is ready for blurring of an entire image by a camera shake, like addition of continuous photographing of still pictures is ready for a larger camera shake where the search range is greater.

On the other hand, in the case where a block matching processing section is used as a vector detector, the search range and the required processing speed vary depending upon an application to be used. Therefore, it cannot be asserted generally that it is better to assure a greater search range.

In particular, when a system having a motion detection engine is configured, it is preferable that a control section of the motion detection section can programmably change the configuration for hierarchical block matching in regard to the search range, hierarchical layer number and so forth. For example, the control section preferably operates in accordance with a program like, for example, a CPU (Central Processing Unit) or a DSP (Digital Signal Processor).

Further, in a field relating to a codec process such as the MPEG, a processor-based motion detection engine or a processor-based DCT processing engine has been proposed for a long time. For example, an engine wherein a SAD arithmetic operation unit and a plurality of processors are connected in parallel to implement a programmable motion detection process has been proposed already.

However, in regard to a process for which a real-time property is required such as MPEG codec or video frame NR, while a programmable configuration is demanded, there is a demand that processing be carried out at a high speed.

For example, Patent Document 1 mentions a problem of the processing time in the case where a hierarchical block matching process is carried out. The Patent Document 1 solves a problem that, if, upon transition of motion vector detection on a reduced plane and motion vector detection on a base plane, a result of the motion vector detection of the reduced plane is not known, then a reference block for the motion vector detection on the base plane cannot be accessed, by constructing pipelines.

However, in order to program such complicated pipelines, various states in internal processing are checked, which complicates the CPU configuration.

According to an embodiment of the disclosed technology, there is provided an image processing apparatus including an image processing section adapted to calculate a motion vector of an image signal between a plurality of frames, a first control section adapted to programmably control the image processing section to execute motion detection, and a second control section adapted to control the image processing section in a processing state determined in advance to execute motion detection.

In the image processing apparatus, as a calculation process for a motion vector by the image processing section, appropriate motion vector calculation suitable for a state of an image signal can be carried out by combining or selectively using the processing state wherein the motion vector calculation is controlled programmably and the processing state determined in advance.

According to another embodiment of the disclosed technology, there is provided an image processing method including a image process of calculating a motion vector of an image signal between a plurality of frames, a first controlling process of programmably controlling execution of the image process to execute motion detection, and a second controlling process of controlling the image process in a processing state determined in advance to execute motion detection.

With the image processing apparatus, motion vector calculation can be carried out in an appropriate controlling state. For example, when a program matching process is carried out, programmable control ready for variations of the hierarchical layer number, matching parallel operation number and search range can be applied. On the other hand, for a real time process, a control section prepared for each of modes for exclusive use or the like can be applied, and the block matching process can be carried out automatically.

The above and other features and advantages of the disclosed technology will become apparent from the following description and the appended claims, taken in conjunction with the accompanying drawings in which like parts or elements denoted by like reference characters.

### BRIEF DESCRIPTION OF THE DRAWINGS

FIG. 1 is a block diagram showing an example of a configuration of an imaging apparatus as an image processing apparatus according to an embodiment of the disclosed technology;

FIG. 2 is a schematic view illustrating an example of a noise reduction process of a picked up image by the imaging apparatus;

FIG. 3 is a schematic view illustrating another example of a noise reduction process of a picked up image by the imaging apparatus;

FIGS. 4 and 5 are schematic views showing examples of a base plane and a reduced plane;

FIGS. 6A to 6C are schematic views illustrating an example of a process for a base plane and a reduced plane;

FIG. 7 is a schematic view illustrating an example of operation of a motion detection and motion compensation section of the imaging apparatus;

FIG. 8 is a block diagram showing an example of a configuration of the motion detection and motion compensation section of the imaging apparatus;

FIGS. 9 and 10 are block diagrams showing different examples of a detailed configuration of part of the motion detection and motion compensation section;

FIG. 11 is a block diagram showing an example of a configuration of an image superposition section of the imaging apparatus;

FIGS. 12 and 13 are block diagrams showing different examples of a controlling configuration of the motion detection and motion compensation section;

FIGS. 14A and 14B are diagrammatic views illustrating an example of real time operation and general purpose operation of the imaging apparatus for comparison, respectively;

FIGS. 15A and 15B are diagrammatic views illustrating an example of a real time operation and an example of a rectangle operation of the imaging apparatus, respectively;

FIG. 16 is a diagrammatic view illustrating an example of a flow of the real time operation of the imaging apparatus;

FIG. 17 is a diagrammatic view illustrating an example of a processing procedure of the real time operation of the imaging apparatus;

FIG. 18 is a diagrammatic view illustrating an example of processing by the real time operation of the imaging apparatus;

FIG. 19 is a diagrammatic view illustrating an example of processing by the rectangle operation of the imaging apparatus;

FIG. 20 is a processing timing chart illustrating an example of operation of the imaging apparatus;

FIGS. 21 and 22 are flow charts illustrating an example of image processing of the imaging apparatus;

FIGS. 23 and 24 are flow charts illustrating an example of a hierarchical matching process of the imaging apparatus; and

FIG. 25 is a view illustrating an example of a hierarchical layer number and a reduction ratio of a reduced plane depending upon an image size by the imaging apparatus.

### DETAILED DESCRIPTION OF THE PREFERRED EMBODIMENT

In the following, an embodiment of the disclosed technology is described in the following order:

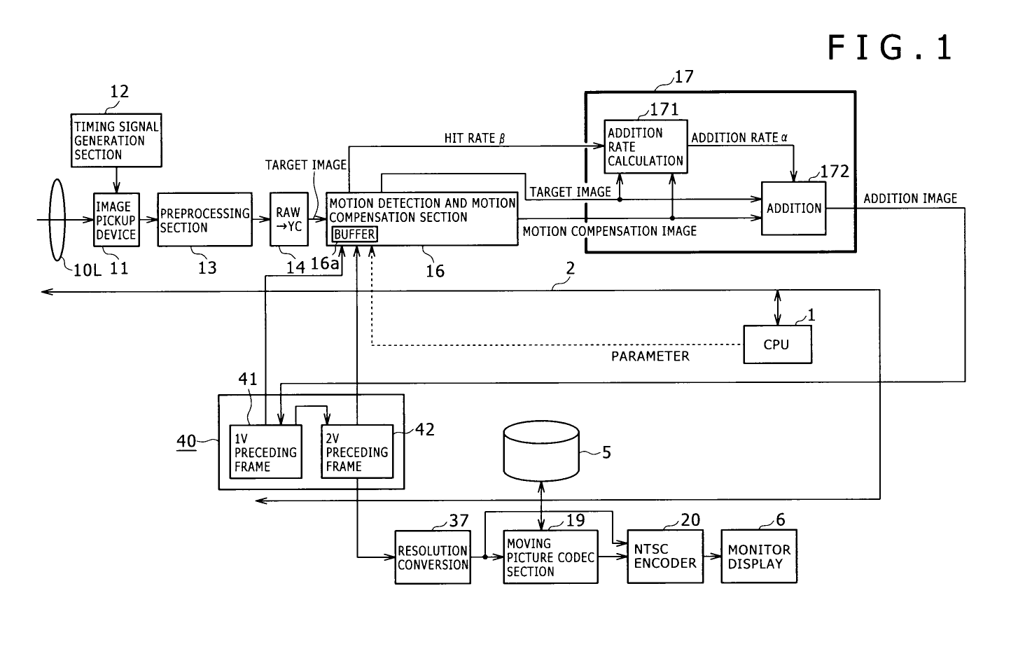

### 1. Configuration of the Imaging Apparatus (FIGS. 1 to 3)

### 2. Processing Configuration of the Motion Detection and Motion Compensation Section (FIGS. 4 to 11)

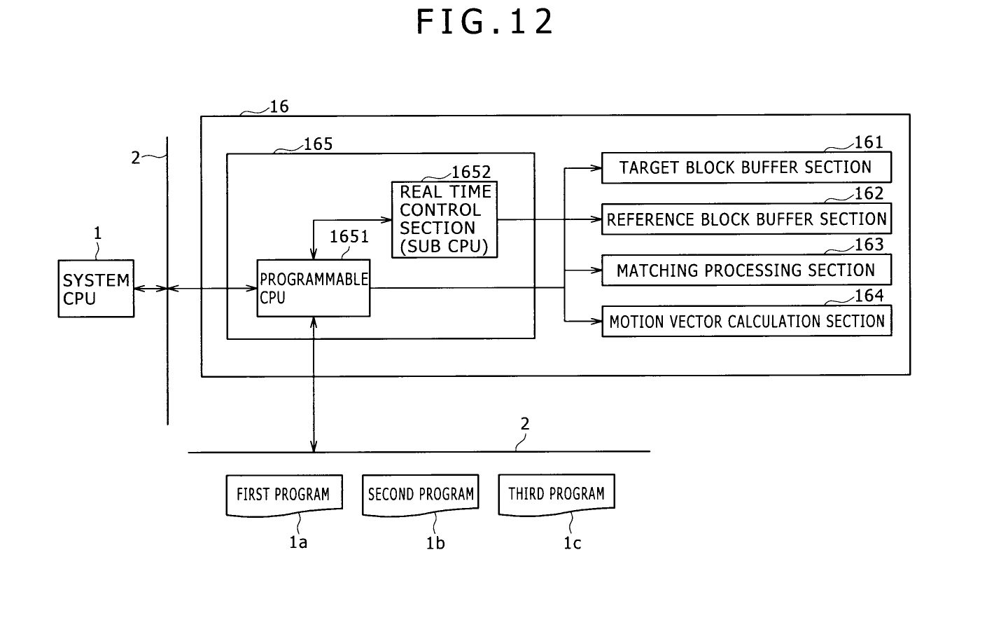

### 3. Controlling Configuration of the Motion Detection and Motion Compensation Section (FIGS. 12 to 20 and 25)

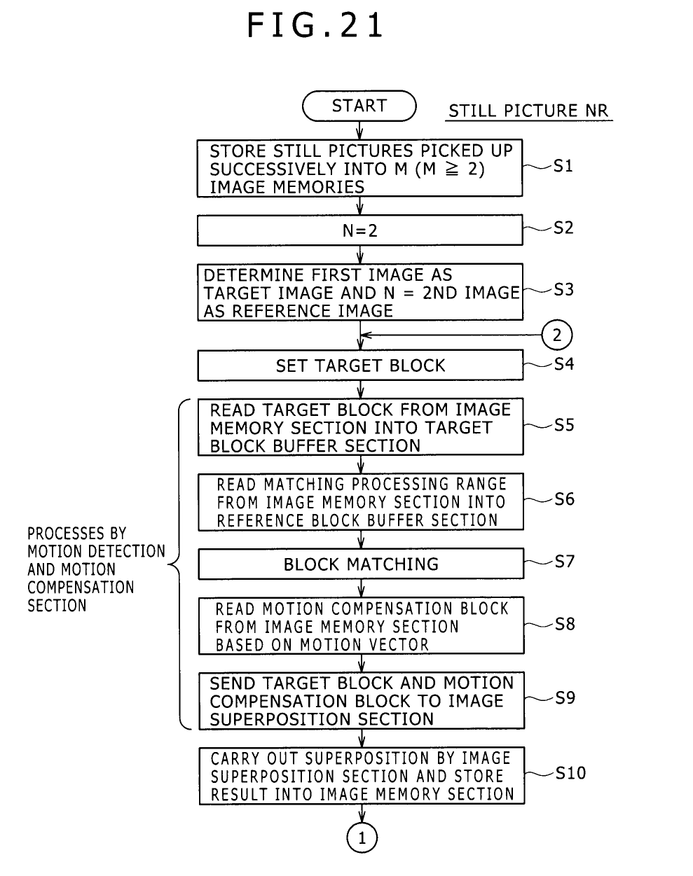

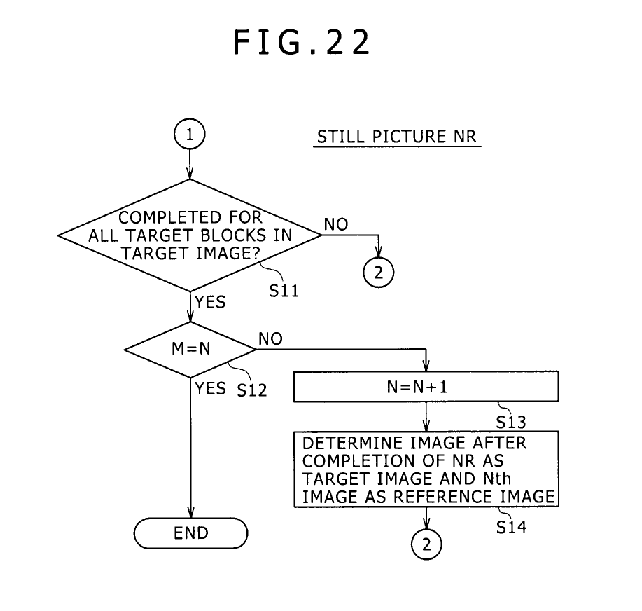

### 4. Flow of an Outline of the Noise Reduction Process for Picked Up Images (FIGS. 21 and 22)

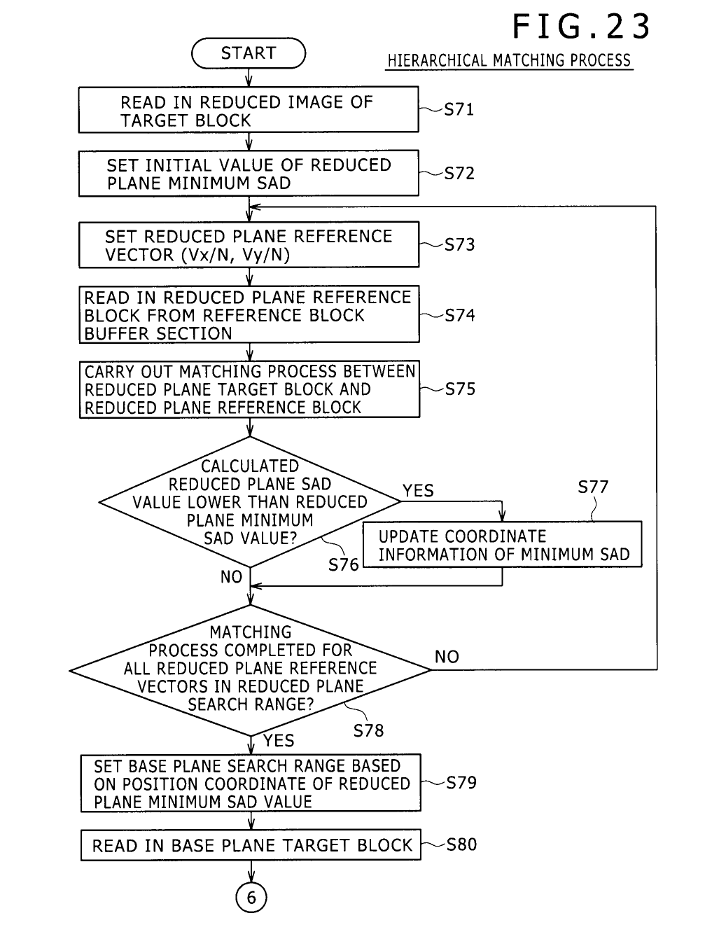

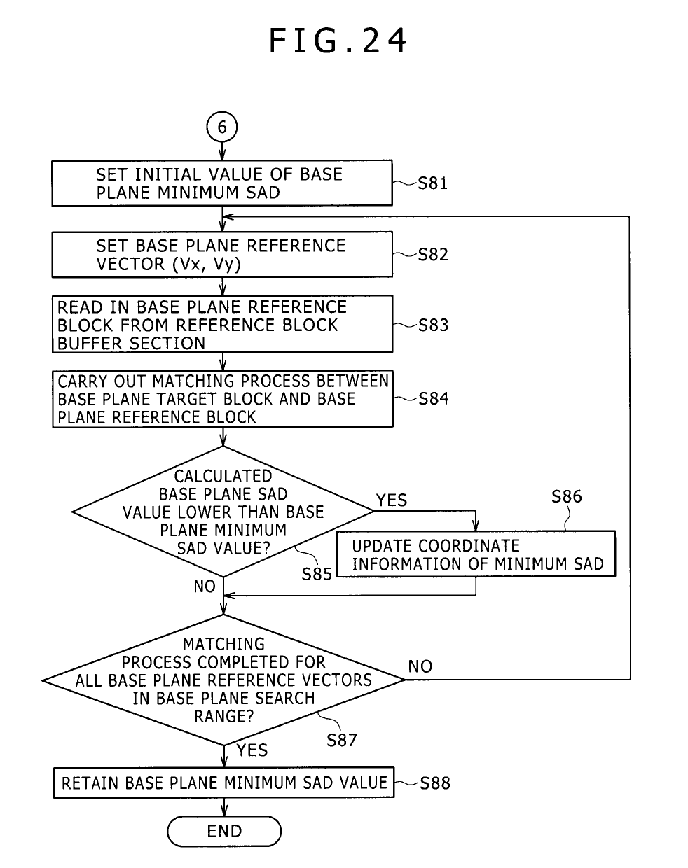

### 5. Example of a Flow of the Hierarchical Block Matching Process (FIGS. 23 and 24)

### 1. Configuration of the Imaging Apparatus

As the embodiment of the disclosed technology, an imaging apparatus as an image processing apparatus is described with reference to the accompanying drawings.

The imaging apparatus includes an image processing section which carries out an image process of detecting a motion vector between two screen images by block matching, producing a motion compensation image using the detected motion vector, and superposing the produced motion compensation image and an image of an object of noise reduction with each other to carry out noise reduction. First, an outline of this image process is described.

In the imaging apparatus, a plurality of images picked up successively are positioned using motion detection and motion compensation and then superposed or added so that an image having reduced noise can be obtained. In particular, since noise in a plurality of images appears at random, if the images of same contents are superposed, then the noise is reduced in the resulting image.

It is to be noted here that, in the following description, to superpose a plurality of images to reduce noise using motion detection and motion compensation is referred to as NR (Noise Reduction), and an image having reduced noise by NR is referred to as NR image.

Further, in the present specification, a screen image to which noise reduction is to be applied is defined as target screen image or target frame, and a screen image to be superposed is defined as a reference screen image or reference frame. Screen images picked up successively exhibit displacement in image as a result of a camera shake by an image pickup person or the like, and in order to carry out superposition of the images, positioning of the images is significant. What is to be taken into consideration here is that not only a shake of an entire screen image such as a camera shake but also a movement of an image pickup object in the screen image exist.

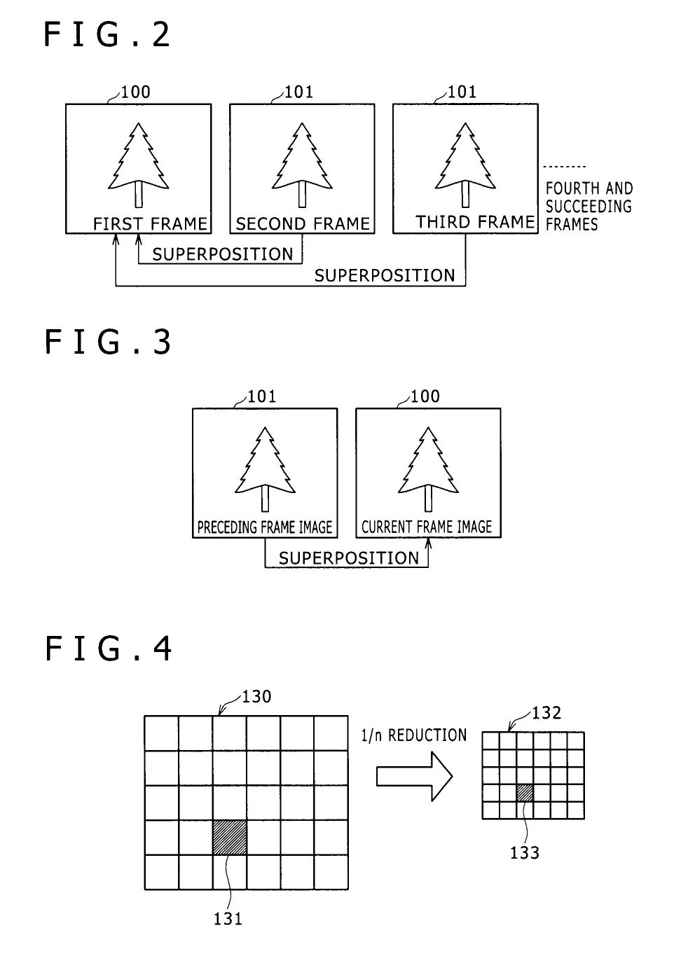

In the imaging apparatus of the present example, upon still picture image pickup, a plurality of images are picked up at a high speed as seen in FIG. 2, and the image picked up first is determined as a target frame 100. Then, a predetermined number of picked up images beginning with the second picked up image are determined as reference frames 101. Then, superposition of the target frame 100 and the reference frames 101 is carried out, and a resulting image is recorded as a still picture picked up image. In particular, if an image pickup person presses a shutter button of the imaging apparatus, then the predetermined number of images are picked up at a high speed, and on the image or frame picked up first, a plurality of images or frames picked up later in time are superposed.

On the other hand, upon moving picture image pickup, an image of a current frame currently being outputted from the image pickup device is determined as an image of a target frame 100, and an image in the past of a preceding frame is determined as an image of a reference frame 101. Accordingly, in order to carry out noise reduction for the image of the current frame, the image of the preceding frame to the current frame is superposed on the image of the current frame.

A configuration of the imaging apparatus which carries out such motion detection and motion compensation as just described is described with reference to FIG. 1.

The imaging apparatus shown in FIG. 1 includes a CPU (Central Processing Unit) 1 connected to a system bus 2, and further includes a picked up image signal processing system, a user operation inputting section 3, a large capacity memory 40, a recording and reproduction apparatus section 5 and so forth connected to the system bus 2. It is to be noted that, though not shown, the CPU 1 includes a ROM (Read Only Memory) which stores a program for carrying out various software processes, a RAM (Random Access Memory) for a work area, and so forth. This similarly applies also to other CPUs described in the present specification. Also, the CPU 1 is sometimes referred to as system CPU 1 in order to distinguish the CPU 1 from the other CPUs hereinafter described.

The large capacity memory 40 is configured from a memory of a comparatively large storage capacity such as a DRAM and a controller for the memory, and is an image memory which stores image data of one frame or a plurality of frames. The memory controller may be provided externally of the large capacity memory 40 such that writing into and reading out of the memory are controlled by the memory controller through the system bus 2 or the like. It is to be noted that the large capacity memory 40 is hereinafter referred to as image memory 40.

The picked up image signal processing system of the imaging apparatus of FIG. 1 receives an image pickup recording starting operation through the user operation inputting section 3 and carries out such a recording process of picked up image data as hereinafter described. Further, the picked up image signal processing system of the imaging apparatus of FIG. 1 receives a reproduction starting operation of a picked up recorded image through the user operation inputting section 3 and carries out a reproduction process of picked up image data recorded on a recording medium of the recording and reproduction apparatus section 5.

In the picked up image processing system, incident light from an image pickup object through a camera optical system not shown including an image pickup lens 10L is irradiated upon and picked up as an image by the image pickup device 11. In the example shown in FIG. 1, the image pickup device 11 is configured from a CCD (Charge Coupled Device) imager. It is to be noted that the image pickup device 11 may otherwise be configured from any other imager such as a CMOS (Complementary Metal Oxide Semiconductor) imager.

In the imaging apparatus of the present embodiment, if an image pickup recording starting operation is carried out, then an image inputted through the image pickup lens 10L is converted into a picked up image signal by the image pickup device 11. The picked up image signal is outputted as an analog picked up image signal in the form of a raw signal of a Bayer array configured from three primary colors of red (R), green (G) and blue (B) as a signal synchronized with a timing signal from a timing signal generation section 12. The outputted analog picked up image signal is supplied to a preprocessing section 13 and undergoes preprocessing such as defect correction and gamma correction. A resulting signal is supplied to a data conversion section 14.

The data conversion section 14 converts the analog picked up image signal of the raw signal inputted thereto into digital image data, that is, YC data, configured from a luminance signal component Y and color difference signal components Cb/Cr. The data conversion section 14 supplies the digital image data as a target image to a motion detection and motion compensation section 16. In the motion detection and motion compensation section 16, the digital image data are stored into a region for a target image in a buffer memory 16a.

Further, the motion detection and motion compensation section 16 acquires an image signal of a preceding frame written in the image memory 40 already as a reference image. The image data of the acquired reference image are stored into a region for a reference image of the buffer memory 16a of the motion detection and motion compensation section 16. An example of a particular configuration of the buffer memory 16a is hereinafter described.

The motion detection and motion compensation section 16 uses the image data of the target frame and the image data of the reference frame to carry out a block matching process hereinafter described to detect a motion vector in a unit of a target block. When a motion vector is to be detected, a search of a reduced plane and a search of a base plane are carried out. When a motion vector is detected, a hit rate β representative of the accuracy in detection of the motion vector is calculated and outputted.

Then, the motion detection and motion compensation section 16 carries out motion compensation in a unit of a block based on motion vectors detected in such a manner as described above to produce a motion compensation image. The produced motion compensation image and the data of the original target image are supplied to an addition rate calculation section 171 and an addition section 172 which configure an image superposition section 17.

The addition rate calculation section 171 calculates an addition rate a between the target image and the motion compensation image based on the hit rate β and supplies the calculated addition rate α to the addition section 172.

The addition section 172 carries out an addition process of the data of the target image and the data of the motion compensation image at the addition rate α thereby to carry out an image superposition process to obtain a noise-reduced addition image. It is to be noted that the noise-reduced addition image is hereinafter referred to as NR image.

The image data of the noise-reduced addition image as a result of the superposition outputted from the addition section 172 are stored into the image memory 40.

The image memory 40 stores and retains the data of the NR image for one frame into a 1V preceding frame storage section 41 in the image memory 40. The image memory 40 includes, in addition to the 1V preceding frame storage section 41, a 2V preceding frame storage section 42. Stored data in the 1V preceding frame storage section 41 are transferred to the 2V preceding frame storage section 42 after every one period. In an interlocking relationship with the transfer of stored data from the 1V preceding frame storage section 41 to the 2V preceding frame storage section 42, data stored in the 2V preceding frame storage section 42 are read out into a resolution conversion section 37.

It is to be noted that, while, in the configuration shown in FIG. 1, image data for two frames are stored, in the case where image data of a greater number of frames in the past are required by the motion detection and motion compensation section 16 or the like, image data of a greater number of part frames may be stored and used as reference frames.

The resolution conversion section 37 converts the data read out from the 2V preceding frame storage section 42 into image data of a resolution for display or for outputting, and in the case where the image data after the conversion are to be recorded by the recording and reproduction apparatus section 5, the image data are converted by a moving picture codec section 19. The image data obtained by the conversion by the moving picture codec section 19 are recorded on a recording medium by the recording and reproduction apparatus section 5 and then read out from the recording medium by the recording and reproduction apparatus section 5 when necessary.

Then, the image data outputted from the resolution conversion section 37 or the image data reproduced by the recording and reproduction apparatus section 5 are supplied to an NTSC (National Television System Committee) encoder 20. The image data are converted into a standard color video signal of the NTSC system by the NTSC encoder 20 and is supplied to a monitor display unit 6 which is configured, for example, from a liquid crystal display panel. Since the standard color video signal is supplied to the monitor display unit 6 in this manner, a monitor image is displayed on the display screen of the monitor display unit 6. It is to be noted that, though not shown in FIG. 1, an output video signal from the NTSC encoder 20 can be led out to the outside through a video output terminal.

### 2. Processing Configuration of the Motion Detection and Motion Compensation Section

The motion detection and motion compensation section 16 carries out a block matching process using a SAD value which is a sum of absolute difference values to carry out motion vector detection.

### <Outline of the Hierarchical Block Matching Process>

In a general motion vector detection process based on block matching, a reference block is successively shifted in a pixel unit, that is, in a unit of one pixel or a plurality of pixels, and a SAD value regarding the reference block at individual shifted positions is calculated. Then, from among the calculated SAD values, a SAD value which indicates a minimum value is detected, and then a motion vector is detected based on the reference block position at which the minimum SAD value is exhibited.

However, with such a motion vector detection process as just described, since the reference block is successively shifted in a pixel unit within the search range, the number of times of the matching process for calculating a SAD value increases in proportion to the search range. Thus, there is a problem that this increases the matching processing time and increases also the capacity of the SAD table.

Therefore, a reduced image is produced for each of the target image or target frame and the reference images or reference frames, and the produced reduced images are used to carry out block matching. Then, block matching based on the original target image is carried out based on a result of the motion detection with regard to the reduced images. It is to be noted that a reduced image is hereinafter referred to as reduced plane, and an original image which is not reduced is hereinafter referred to as base plane. Accordingly, in the present example, block matching is carried out with regard to reduced planes first, and then a result of the block matching is used to carry out block matching with regard to base planes.

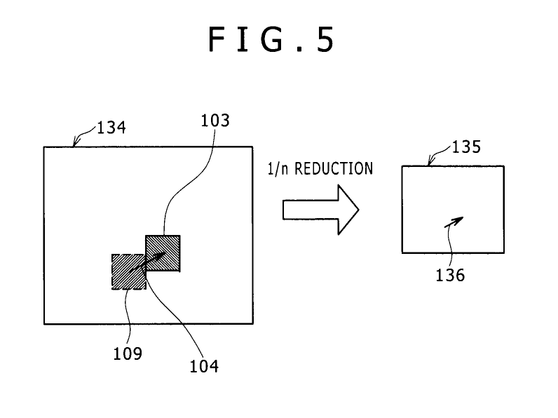

FIGS. 4 and 5 illustrate image reduction of a target frame or image and a reference frame or image. In particular, in the present example, a base plane target frame 130 is reduced to 1/n (n is a positive value) in both of a horizontal direction and a vertical direction to produce a reduced plane target block 132, for example, as seen in FIG. 4. Accordingly, each of a plurality of base plane target blocks 131 formed by dividing the base plane target frame 130 corresponds, in the reduced plane target frame, to a reduced plane target block 133 which has a size reduced to 1/n×1/n in the horizontal and vertical directions.

Then, each reference frame is reduced in accordance with the image reduction rate 1/n of the target frame. In particular, a base plane reference frame 134 is reduced to 1/n in both of the horizontal and vertical directions to make a reduced plane reference frame 135 as seen in FIG. 5. Then, a motion vector 104 regarding a motion compensation block 103 detected on the base plane reference frame 134 is detected, on the reduced plane reference frame 135, as a reduced plane motion vector 136 reduced to 1/n×1/n.

It is to be noted that the image reduction rates of the target frame and the reference frame are equal to each other. However, in order to reduce the amount of arithmetic operation, image reduction rates different from each other may be used for the target frame or image and the reference frame or image. In this instance, the pixel numbers of the frames are adjusted by such a process as pixel interpolation to carry out matching.

Further, while the reduction rates in the horizontal direction and the vertical direction are equal to each other, the reduction rate may differ between the horizontal direction and the vertical direction. For example, if the reduction rate of 1/n is applied to the horizontal direction and the reduction rate of 1/m (m is a positive value and is not equal to n) is applied to the vertical direction, then the reduced screen image has a size of 1/n×1/m with respect to the original screen image.

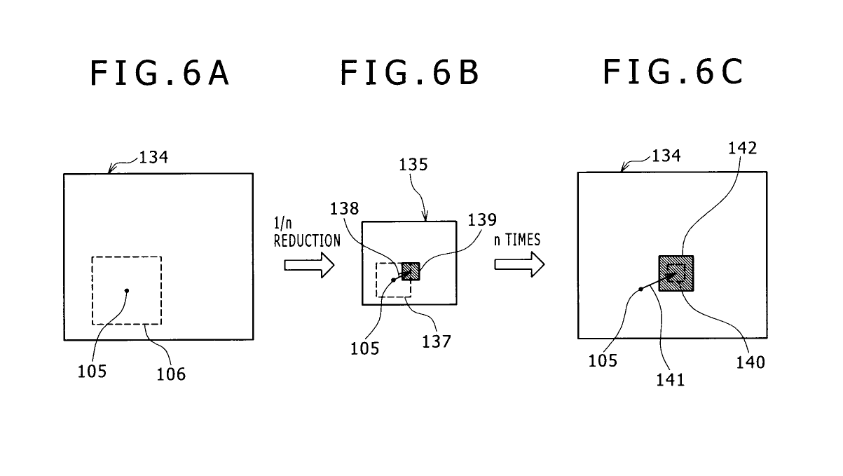

FIGS. 6A to 6C illustrate a relationship between a reduced plane reference vector and a base plane reference vector. It is assumed that, in the base plane reference frame 134, a motion detection origin 105 and a search range 106 are determined in such a manner as seen in FIG. 6A. At this time, on the reduced plane reference frame 135 reduced to 1/n×1/n, the search range is a reduced plane search range 137 reduced to 1/n×1/n as seen in FIG. 6B.

Further, in the present example, a reduced plane reference vector 138 representative of a positional displacement amount on the reduced plane reference frame 135 from the motion detection origin 105 is set within the reduced plane search range 137. Then, a correlation between a reduced plane reference block 139 and a reduced plane target block 131 (not shown in FIGS. 6A to 6C) at a position pointed to by the reduced plane reference vector 138 is evaluated.

In this instance, since block matching is carried out on the reduced plane, the number of reduced plane reference block positions, that is, of reduced plane reference vectors, with regard to which the SAD value is to be calculated within the reduced plane reference frame 135 can be reduced. Since the number of times of calculation of the SAD value, that is, the number of times of the matching process, is reduced in this manner, the processing speed can be raised as much and the scale of the SAD table can be reduced as much.

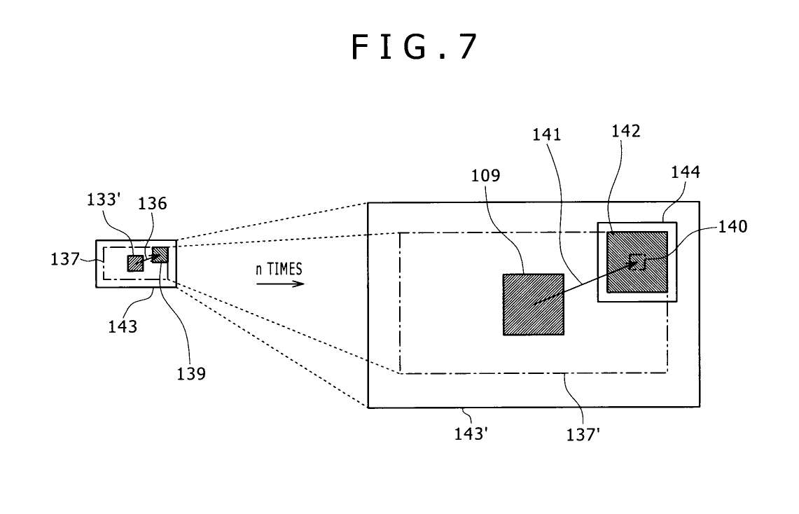

A correlation evaluation by block matching between a plurality of reduced plane reference blocks 139 set in a reduced plane matching process range 143 determined in response to the reduced plane search range 137 and the reduced plane target block 131 is obtained as seen in FIG. 7. By the correlation evaluation, the reduced plane motion vector 136 in the reduced plane reference frame 135 is calculated. The accuracy of the reduced plane motion vector 136 is as low as n times one pixel because the image is reduced to 1/n×1/n. Therefore, even if the calculated reduced plane motion vector 136 is increased to n times, a motion vector 104 of a one-pixel accuracy cannot be obtained on the base plane reference frame 134.

However, it is apparent that, in the base plane reference frame 134, the motion vector 104 of a one-pixel accuracy exists in the proximity of a motion vector obtained by increasing the reduced plane motion vector 136 to n times.

Therefore, in the present example, as shown in FIGS. 6C and 7, a position pointed to by the motion vector obtained by increasing the reduced plane motion vector 136 to n times, that is, by the base plane reference vector 141, on the base plane reference frame 134 is regarded as the center. Within a small region in which it is estimated that the motion vector 104 may exist, a base plane search range 140 is set, and a base plane matching process range 144 is set in response to the thus set base plane search range 140.

Then, as an element which indicates the position in the base plane search range 140, the base plane reference vector 141 on the base plane reference frame 134 is set as seen in FIG. 6C, and a base plane reference block 142 is set to a position pointed to by the base plane reference vector 141. In these settings, a block matching is carried out with regard to the base plane reference frame 134.

The base plane search range 140 and the base plane matching process range 144 set in this manner may be very small ranges. In particular, the base plane search range 140 and the base plane matching process range 144 may be very small in comparison with a search range 137′ and a matching process range 143′ obtained by increasing the reduced plane search range 137 and the reduced plane matching process range 143 to n times which is a reciprocal multiple of the reduction rate as seen in FIG. 7.

Accordingly, in the case where a block matching process is carried out only with regard to a base plane without carrying out hierarchical matching, on the base plane, a plurality of reference blocks are set within the search range 137′ and the matching process range 143′ to carry out arithmetic operation for determining a correlation value with a target block. In contrast, in the hierarchical matching process, the matching process may be carried out only within a very small range as seen from FIG. 7.

Therefore, the number of base plane reference blocks set in the base plane search range 140 and the base plane matching process range 144 which are such very small ranges is reduced significantly, and the number of times of a matching process, that is, the number of times of a correlation value arithmetic operation, and the number of SAD values to be retained can be made very small. Therefore, the advantages that the processing can be carried out at a high speed and that the scale of the SAD table can be reduced can be achieved.

### <Example of the Configuration of the Motion Detection and Motion Compensation Section>

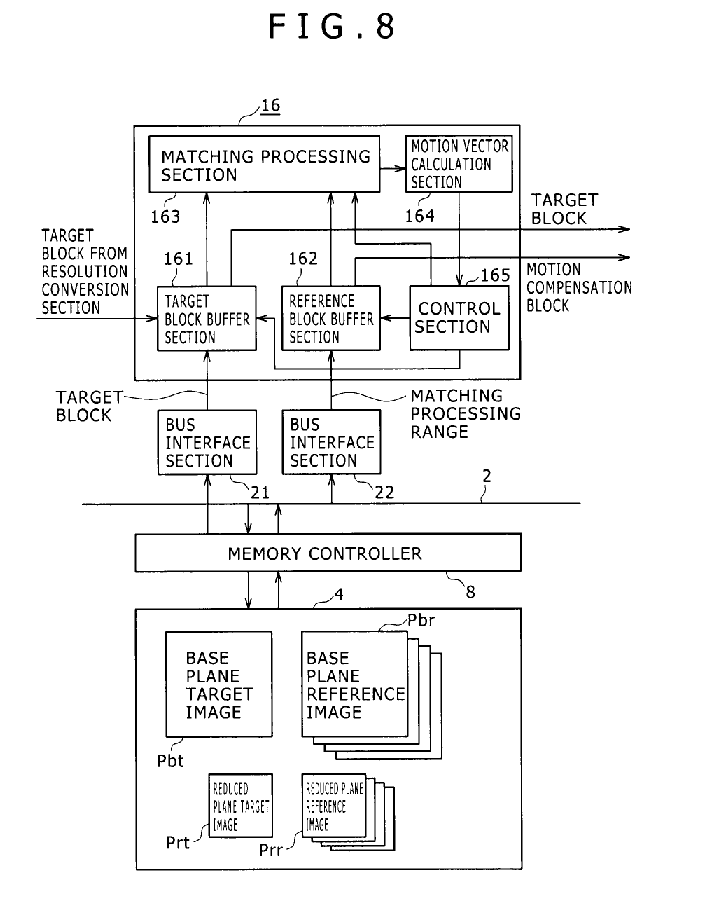

FIG. 8 shows a block diagram of an example of a configuration of the motion detection and motion compensation section 16. Referring to FIG. 8, the motion detection and motion compensation section 16 includes a target block buffer section 161 for retaining pixel data of a target block 102, and a reference block buffer section 162 for retaining pixel data of a reference block 108. The buffer sections 161 and 162 correspond to the buffer memory 16a shown in FIG. 1.

The motion detection and motion compensation section 16 further includes a matching processing section 163 for calculating the SAD value regarding corresponding pixels between the target block 102 and the reference block 108. The motion detection and motion compensation section 16 further includes a motion vector calculation section 164 for calculating a motion vector from SAD value information outputted from the matching processing section 163, and a control section 165 for controlling the components of the motion detection and motion compensation section 16.

Then, the image data stored in the image memory 40 are supplied to the target block buffer section 161 and the reference block buffer section 162 in the motion detection and motion compensation section 16.

Upon still picture image pickup, the following images are read out from the image memory 40 and written into the target block buffer section 161 under the reading control of a memory controller 8. In particular, a reduced plane target block or a base plane target block from an image frame of a reduced plane target image Prt or an image frame of a base plane target image Pbt stored in the image memory 40 is read out from the image memory 40 and written into the target block buffer section 161.

As regards the reduced plane target image Prt or the base plane target image Pbt, for the first image, an image of a frame picked up first after press of the shutter button is read out from the image memory 40 and written as a target block 102 into the target block buffer section 161. When superposition of the image is carried out by block matching with a reference image, a NR image after the superposition is written into the image memory 40, and the target block 102 of the target block buffer section 161 is rewritten with the NR image.

Into the reference block buffer section 162, image data in a reduced plane matching processing range or a base plane matching processing range from an image frame of a reduced plane reference image Prr or a base plane reference image Pbr stored in the image memory 40 are written. As regards the reduced plane reference image Prr or the base plane reference image Pbr, a picked up frame succeeding the first picked up frame is written as the reference block 108 into the image memory 40.

In this instance, in the case where an image superposition process is carried out while a plurality of picked up images picked up successively are fetched, as a base plane reference image and a reduced plane reference image, picked up frames after the first picked up frame are successively fetched one by one into the image memory 40.

After a plurality of picked up images picked up successively are fetched into the image memory 40, motion vector detection is carried out by the motion detection and motion compensation section 16 and the image superposition section 17. Then, in the case where superposition of the images is to be executed, a plurality of picked up frames are retained. The processing after a plurality of picked up images picked up successively are fetched into the image memory 40 is hereinafter referred to as addition after image pickup. In particular, upon addition after image pickup, as base plane reference images and reduced plane reference images, all of a plurality of picked up frames succeeding the first picked up frame are stored into and retain in the image memory 40.

Although the imaging apparatus can use any of addition during image pickup and addition after image pickup, in the present embodiment, processing of addition after image pickup is adopted taking that clean images in which noise is reduced are required even if some processing time is required into consideration.

On the other hand, upon moving picture image pickup, a picked up image frame from the image correction and resolution conversion section 15 is inputted as the target block 102 into the motion detection and motion compensation section 16. Into the target block buffer section 161, a target block extracted from the target frame from the image correction and resolution conversion section 15 is written. Further, a picked up frame immediately preceding to the target frame and stored in the image memory 40 is determined as the reference block 108. Into the reference block buffer section 162, a base plane matching processing range or a reduced plane matching processing range from this reference frame, that is, from the base plane reference image Pbr or the reduced plane reference image Prr, is written.

Upon such moving picture image pickup, a picked up image frame preceding at least by one frame and to be used for block matching with the target frame from the motion detection and motion compensation section 16 is retained as the base plane reference image Pbr and the reduced plane reference image Prr.

The matching processing section 163 carries out a matching process with regard to the reduced plane and a matching process with regard to the base plane for the target block stored in the target block buffer section 161 and the reference block stored in the reference block buffer section 162.

Here, a case is considered in which data stored in the target block buffer section 161 are image data in a reduced plane target block and data stored in the reference block buffer section 162 are image data in a reduced plane matching processing range extracted from the reduced screen reference screen image. In this instance, the matching processing section 163 executes a reduced plane matching process. Further, data stored in the target block buffer section 161 are image data of a base plane target block. In the case where data stored in the reference block buffer section 162 are image data of a base plane matching processing range extracted from a base plane target block, the matching processing section 163 executes a base plane matching process.

In order to detect the strength in correlation between a target block and a reference block in block matching, the matching processing section 163 uses luminance information of image data to carry out SAD value calculation. Then, the matching processing section 163 detects a minimum SAD value and detects a reference block which exhibits the minimum SAD value as a highest correlation reference block.

It is to be noted that, in the present embodiment, calculation of a SAD value is carried out for both of a luminance signal and color difference signals, and the SAD value of the luminance signal and the SAD values of the color difference signals are weighted-added to obtain a final SAD value. An example of this process of a luminance signal and color difference signals is hereinafter described.

The motion vector calculation section 164 detects a motion vector of a reference block with respect to a target block from a result of the matching process of the matching processing section 163. In the present example, the motion vector calculation section 164 detects and retains a minimum value of the SAD value.

The motion vector calculation section 164 controls processing operation of a hierarchical block matching process of the motion detection and motion compensation section 16 under the control of the system CPU 1. An example of the controlling operation by the control section 165 is hereinafter described.

### <Example of the Configuration of the Target Block Buffer>

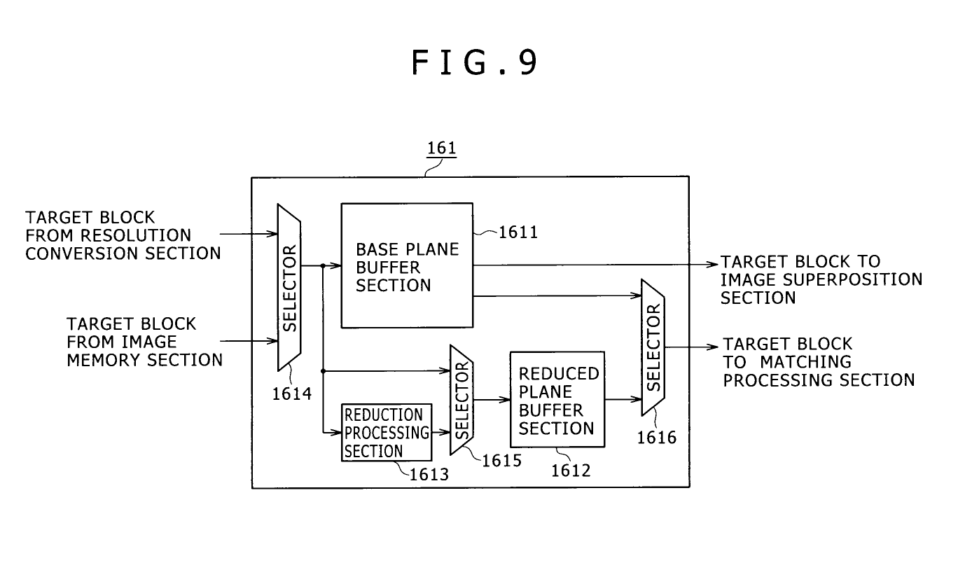

FIG. 9 shows a block diagram of an example of a configuration of the target block buffer. Referring to FIG. 9, the target block buffer section 161 shown includes a base plane buffer section 1611, a reduced plane buffer section 1612, a reduction processing section 1613, and selectors 1614, 1615 and 1616. The selectors 1614, 1615 and 1616 are selectively controlled in accordance with a selection controlling signal from the control section 165 although not shown in FIG. 9.

The base plane buffer section 1611 temporarily retains a base plane target block. The base plane buffer section 1611 sends the base plane target block to the image superposition section 17 and supplies the base plane target block to the selector 1616.

The reduced plane buffer section 1612 temporarily retains a reduced plane target block. The reduced plane buffer section 1612 supplies the reduced plane target block to the selector 1616.

The reduction processing section 1613 receives, upon moving picture image pickup, a target block sent thereto from the image correction and resolution conversion section 15 as described hereinabove and produces a reduced plane target block. The reduced plane target block from the reduction processing section 1613 is supplied to the selector 1615.

The selector 1614 outputs, upon moving picture image pickup, a target block from the data conversion section 14, that is, a base plane target block. Upon still picture image pickup, the selector 1614 outputs a base plane target block or a reduced plane target block read out from the image memory 40. Such outputs are selectively outputted in accordance with a selection controlling signal from the control section 165. The outputs are supplied to the base plane buffer section 1611, the reduction processing section 1613 and the selector 1615.

The selector 1615 selects and outputs, upon moving picture image pickup, a reduced plane target block from the reduction processing section 1613, but selects and outputs, upon still picture image pickup, a reduced plane target block from the image memory 40, in accordance with a selection controlling signal from the control section 165. The output of the selector 1615 is supplied to the reduced plane buffer section 1612.

The selector 1616 outputs, upon block matching on a reduced plane, a reduced plane target block from the reduced plane buffer section 1612 in accordance with a selection controlling signal from the selector 1615. However, upon block matching on a base plane, the selector 1616 outputs a base plane target block from the base plane buffer section 1611. The outputted reduced plane target block or base plane target block is sent to the matching processing section 163.

### <Example of the Configuration of the Reference Block Buffer>

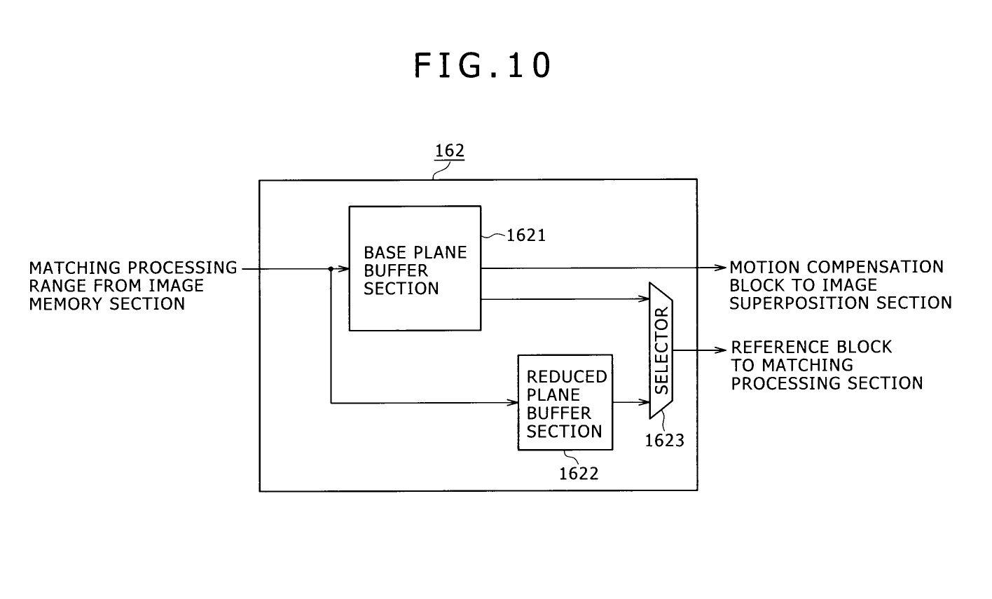

An example of a configuration of the reference block buffer section 162 is shown in FIG. 10. Referring to FIG. 10, the reference block buffer section 162 includes a base plane buffer section 1621, a reduced plane buffer section 1622, and a selector 1623. The selector 1623 is selectively controlled in accordance with a selection controlling signal from the control section 165 although omitted in FIG. 10.

The base plane buffer section 1621 temporarily stores a base plane reference block from the image memory 40 and supplies the base plane reference block to the selector 1623 and sends the base plane reference block as a motion compensation block to the image superposition section 17.

The reduced plane buffer section 1622 temporarily stores a reduced plane reference block from the image memory 40. The reduced plane buffer section 1622 supplies the reduced plane reference block to the selector 1623.

The selector 1623 outputs, upon block matching between reduced planes, a reduced plane reference block from the reduced plane buffer section 1612 in accordance with a selection controlling signal from the selector 1615. Upon block matching between base planes, the selector 1623 outputs a base plane reference block from the base plane buffer section 1611. The outputted reduced plane reference block or base plane reference block is sent to the matching processing section 163.

### <Example of the Configuration of the Image Superposition Section>

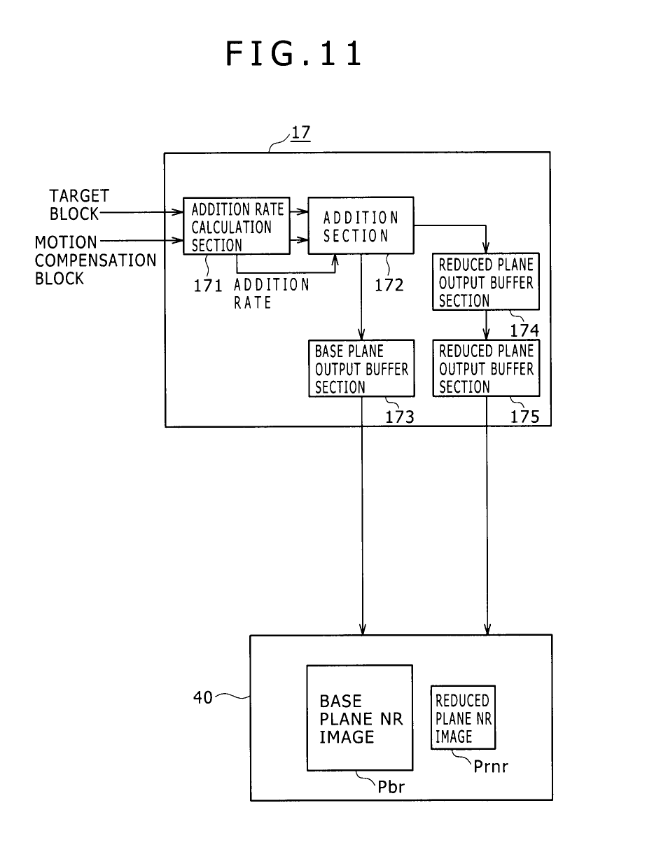

A block diagram of an example of a configuration of the image superposition section 17 is shown in FIG. 11. Referring to FIG. 11, the image superposition section 17 includes an addition rate calculation section 171, an addition section 172, a base plane output buffer section 173, a reduced plane production section 174, and reduced plane output buffer section 175.

Output image data of the image superposition section 17 are compressed by a data compression section 35 and stored into the image memory 40.

The addition rate calculation section 171 receives a target block and a motion compensation block from the motion detection and motion compensation section 16 and determines an addition rate between them in response to whether the addition method to be adopted is the simple addition method or the average addition method. The addition rate calculation section 171 supplies the determined addition rate to the addition section 172 together with the target block and the motion compensation block.

A base plane NR image of a result of the addition by the addition section 172 is written into the image memory 40 after it is compressed. Further, the base plane NR image of the result of the addition by the addition section 172 is converted into a reduced plane NR image by the reduced plane production section 174, and the reduced plane NR image from the reduced plane production section 174 is written into the image memory 40.

### 3. Controlling Configuration of the Motion Detection and Motion Compensation Section

Now, an example of a controlling process of a motion detection operation and a motion compensation operation in the motion detection and motion compensation section 16 is described.

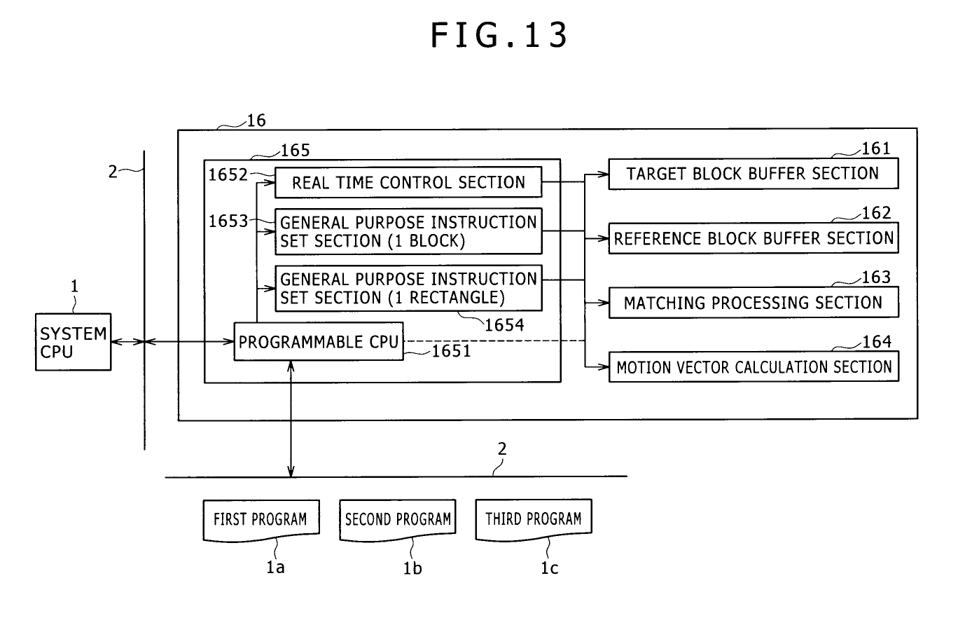

FIGS. 12 and 13 show different configurations of the control section 165 of the motion detection and motion compensation section 16.

FIG. 12 shows a first configuration according to the present embodiment, which includes a sub CPU for exclusive use for a moving picture NR process for which high speed operation based on pipeline operation is required while the CPU accesses all slaves for all of the other processes. FIG. 13 shows a second configuration developed from the first configuration. In the second configuration shown in FIG. 13, the CPU has no interface to slaves and a sub CPU is provided in response to the particle size of processing from processing of a unit of a block to pipeline processing while the CPU is simplified in configuration.

In regard to real time control and rectangular control, a control section can be configured in two different points of view including a configuration which can carry out control making most of high speed processing and another configuration which can carry out control making use of flexibility.

The flexibility here signifies that an instruction can be carried out for all blocks, and while hardware resources can be used sufficiently, the CPU must carry out complicated processing and therefore the interfacing between the CPU and the individual processing section is complicated. As the flexibility increases, the contents which can be controlled by the CPU increase and the interfacing is complicated.

The high speed processing is considered to be opposite to the flexibility. By restricting what can be controlled, processes fixed to some degree can be carried out collectively and the processing burden to the CPU decreases. On the other hand, since the interfacing is restricted, the available processing contents are restricted.

The control section 165 in the present embodiment achieves balancing between the flexibility and the high speed processing. To this end, a plurality of configurations for balancing the flexibility and the high speed processing are prepared in the control section 165.

In particular, the control section 165 includes a (flexible) programmable CPU 1651 which programmably controls motion detection to implement motion detection and a real time control section 1652 which incorporates control determined in advance, that is, is specialized for high speed processing, for the motion detection processing section.

The configuration for carrying out the real time control of FIG. 12 is described.

The control section 165 includes a programmable CPU 1651 serving as a first control section, and a real time control section 1652 serving as a second control section which is a sub CPU.

The real time control section 1652 controls processing operation of the image processing sections in the motion detection and motion compensation section 16 in accordance with an instruction from the programmable CPU 1651. The real time control section 1652 is a hardware control section and controls the associated elements in a predetermined processing state to execute motion detection in accordance with an input of an instruction. In particular, the real time control section 1652 can set an operation mode and a size, that is, a pixel number, of an image and automatically carries out processing for one frame in the set operation mode and with the set image size in accordance with an instruction from the programmable CPU 1651. At this time, the real time control section 1652 issues a starting instruction to the target block buffer section 161, reference block buffer section 162, matching processing section 163 and motion vector calculation section 164 and waits an end notification.

The programmable CPU 1651 receives a program stored in and read out from a program memory through the system bus 2. The programmable CPU 1651 executes a controlling process in a procedure in accordance with the program. In FIG. 12, a first program 1a, a second program 1b and a third program 1c are selectively loaded into the programmable CPU 1651. Which one of the programs is to be loaded is controlled by the system CPU 1, for example, in accordance with the operation mode of the imaging apparatus. Upon real time control, a program for carrying out real time control is loaded. In the present embodiment, the real time control is executed when a detection process of a motion vector from an image signal of a moving picture is to be carried out. In particular, when the imaging apparatus is in a mode in which it carries out motion vector detection upon image pickup of a moving picture and processing based on the detection, control in which the programmable CPU 1651 and the real time control section 1652 are used is carried out. On the other hand, when a detection process of a motion vector from an image signal of a still picture is to be carried out, general purpose control in which the general purpose instruction set sections 1653 and 1654 hereinafter described with reference to FIG. 13 are used is carried out.

It is to be noted that a control instruction may be sent directly from the programmable CPU 1651 to the image processing sections in the motion detection and motion compensation section 16. Depending upon the program to be loaded, it is possible to cause the image processing sections in the motion detection and motion compensation section 16 to execute a motion detection operation and a motion compensation operation in accordance with a direct instruction from the programmable CPU 1651. A control state in which a motion detection operation and a motion compensation operation are executed in accordance with a direct instruction from the programmable CPU 1651 is hereinafter referred to as general purpose control state.

Now, the configuration shown in FIG. 13 is described.

In the configuration of FIG. 13, the motion detection and motion compensation section 16 includes, in addition to the programmable CPU 1651 and the real time control section 1652 described hereinabove with reference to FIG. 12, general purpose instruction set sections 1653 and 1654. The general purpose instruction set section 1653 is configured so as to produce an instruction for carrying out processing for one block in accordance with an instruction from the programmable CPU 1651. Meanwhile, the general purpose instruction set section 1654 is configured so as to generate an instruction for carrying out a rectangle process of image data in accordance with an instruction from the programmable CPU 1651. The programmable CPU 1651 does not issue an instruction directly to the processing sections 161 to 164, and therefore, the CPU has a much simplified configuration.

The general purpose instruction set sections 1653 and 1654 send a control instruction to the target block buffer section 161, reference block buffer section 162, matching processing section 163 and motion vector calculation section 164 to execute a motion detection operation and a motion compensation operation.

Accordingly, upon rectangle processing control, the programmable CPU 1651 accesses the processing sections through the general purpose instruction set sections 1653 and 1654 which are rectangle processing sections. For example, if an instruction designating one of rectangles obtained by dividing a screen image of one frame in a horizontal direction is issued, then the general purpose instruction set sections 1653 and 1654 detect a motion vector of this size in a unit of a block.

Upon this rectangle processing, it is easy to change the block size and the hierarchical layer number for the detection of a motion vector, and the degree of freedom of the program is high although parallelization of a motion vector detection process cannot be carried out. On the other hand, upon real time processing, while the block size and the hierarchical layer number for the detection of a motion vector are fixed, motion vector detection on a reduced plane and motion vector detection on a base plane can be parallelized and high speed operation can be carried out.

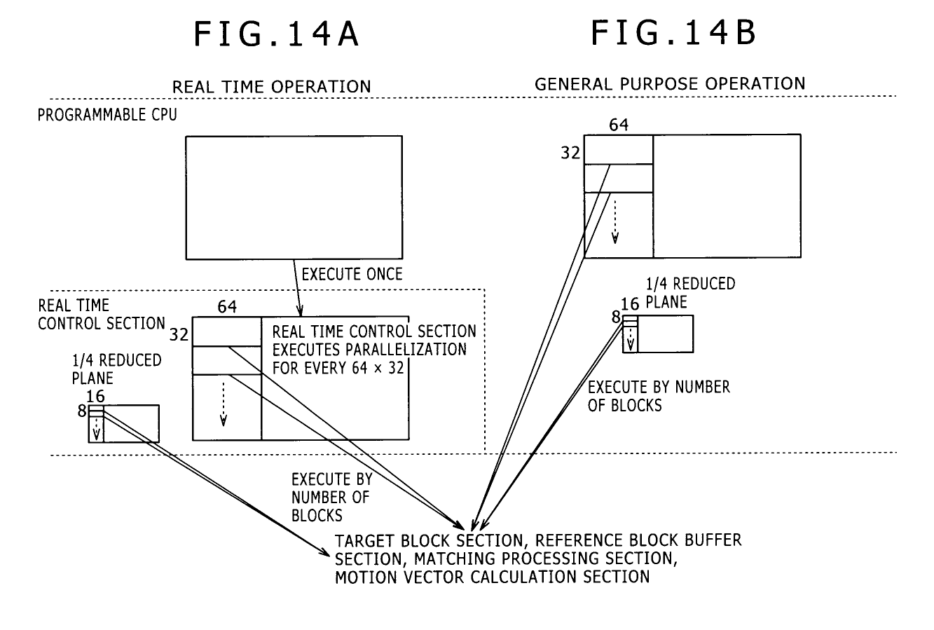

FIGS. 14A and 14B illustrate an outline of the real time operation control state in comparison with that of the general purpose operation control state. Here, the general purpose control state is a state in which the programmable CPU 1651 carries out its control directly.

In particular, FIG. 14A illustrates the real time operation control state, and FIG. 14B illustrates the general purpose operation control state.

In the real time operation control state, if an instruction to start operation is issued from the system CPU 1, then the programmable CPU 1651 issues an instruction to start motion detection and motion compensation determining image data retained in the image memory 40 as a reference frame. In the real time operation control here, the image size of one frame is fixed to 1,440 pixels×1,080 pixels, and the reduced plane is a 1/4 reduced plane.

The real time control section 1652 receives the instruction and executes a process of reading out data of a block of 64 pixels×32 pixels, which is an image block necessary for a matching process, into the reference block buffer section 162 in parallel for the blocks. Also a process of reading out data of the 1/4 reduced plane is executed by the real time control section 1652.

In contrast, upon general purpose operation illustrated in FIG. 14B, the programmable CPU 1651 sends instructions in order to the processing sections so that processing for a required number of blocks is executed. Accordingly, upon general purpose operation, the burden on the programmable CPU 1651 is heavy, and parallelization of processing is difficult.

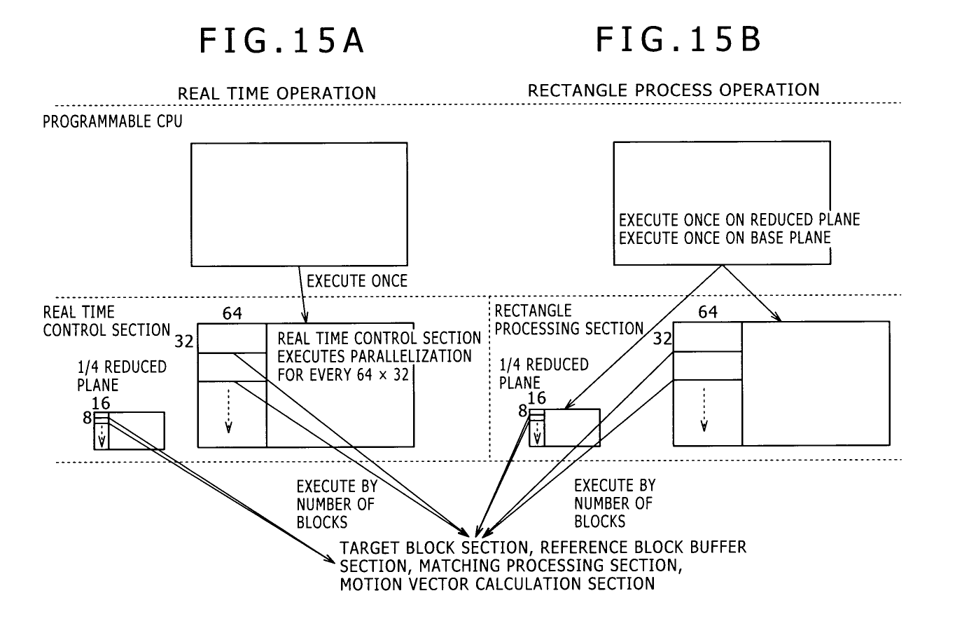

FIGS. 15A and 15B illustrate an outline of a real time operation control state and an outline of a rectangle processing state which is an optimized control state of general purpose control for comparison, respectively. The real time operation control state is same as that described hereinabove with reference to FIG. 14A.

Upon the rectangle processing operation illustrated in FIG. 15B, the programmable CPU 1651 outputs an instruction once in order to carry out processing of a reduced plane and outputs an instruction once in order to carry out processing of a base plane. The general purpose instruction set sections 1653 and 1654 which are rectangle processing sections which receive the respective instructions carry out processing of the base plane and the reduced plane by a number of times equal to the number of blocks in a procedure determined in advance.

Upon the rectangle processing, it is possible to designate an image size and a hierarchical layer number. This makes it easy to deal, for example, with such a case that the hierarchical layer number with which motion detection is to be carried out changes depending upon the image size. For example, in the case where the hierarchical layer number is 3, a motion detection process on a reduced plane, a motion discrimination process on an intermediate plane and a motion discrimination process on a base plane may be carried out in this order.

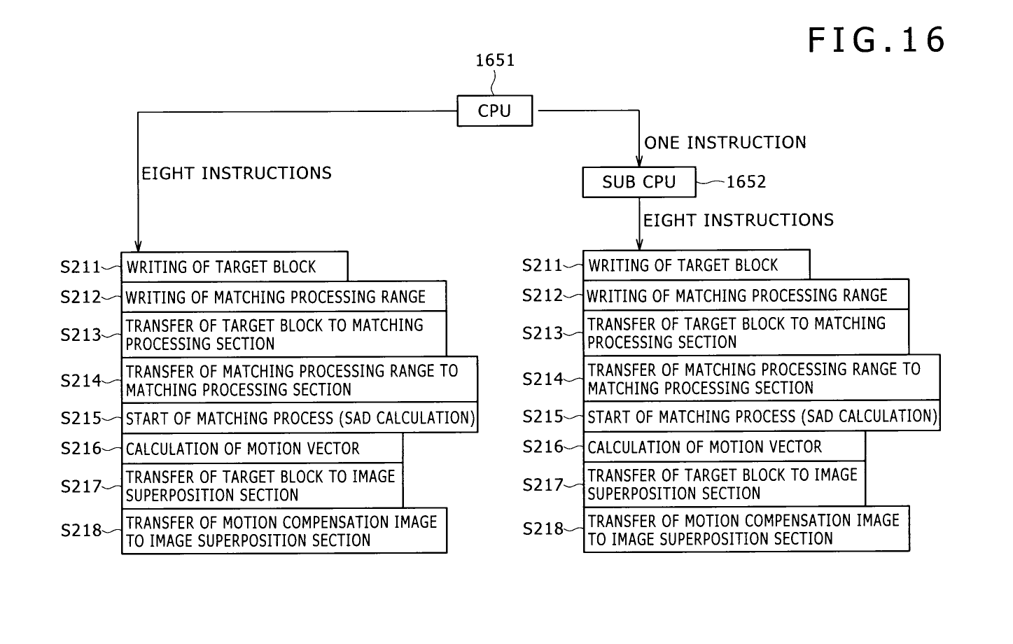

FIG. 16 illustrates an outputting state of instructions from the control section in the real time operation control and an outputting state of instructions from the control section in the general purpose control state.

The outputting state of instructions from the control section in the real time operation control is illustrated on the right side in FIG. 16. At this time, the programmable CPU 1651 outputs one instruction to start real time operation to the real time control section 1652. The real time control section 1652 receives the one instruction and outputs eight instructions to the associated sections.

The following eight processes are carried out in accordance with the eight instructions.

Writing of a target block into the target block buffer section (step S211)

Writing of a matching processing range into the reference block buffer section (step S212)

Transfer of the target block to the matching processing section (step S213)

Transfer of the matching processing range to the matching processing section (step S214)

Start of the matching process (calculation of a SAD value) (step S215)

Calculation a motion vector from a minimum SAD value (step S216)

Transfer of the target block to the image superposition section (step S217)

Transfer of a motion compensation image to the image superposition section (step S218)

The processes at the eight steps are executed at individually appropriate timings in accordance with the respective instructions.

Meanwhile, in the case of the general purpose control state illustrated on the left side in FIG. 16, the programmable CPU 1651 successively outputs eight instructions for carrying out the processes at the eight steps.

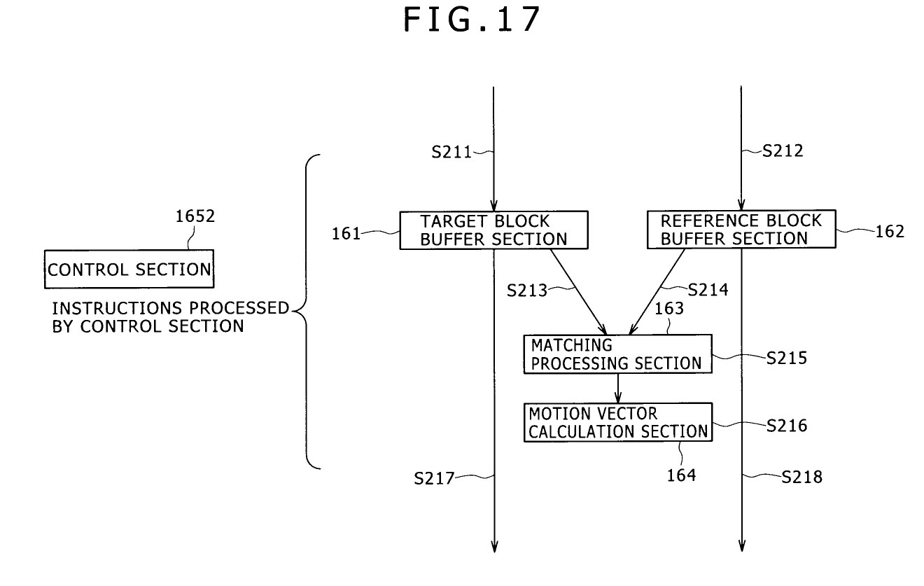

FIG. 17 illustrates a flow in which the processes are carried out in accordance with the eight instructions from the real time control section 1652.

Referring to FIG. 17, writing of a target block into the target block buffer section 161 at step S211 and writing of a matching processing range into the reference block buffer section 162 at step S212 are carried out in parallel. Then, also the transfer processes of the data into the matching processing section 163 at steps S213 and S214 are carried out in parallel, and start of calculation by the matching processing section 163 at step S215 is carried out. Then, when the calculation of such SAD values is completed, calculation of a motion vector by the motion vector calculation section 164 at step S216 is carried out. Then, when the calculation of such motion vectors is completed, transfer of the target block to the image superposition section at step S217 and transfer of the motion compensation image to the image superposition section at step S218 are carried out.

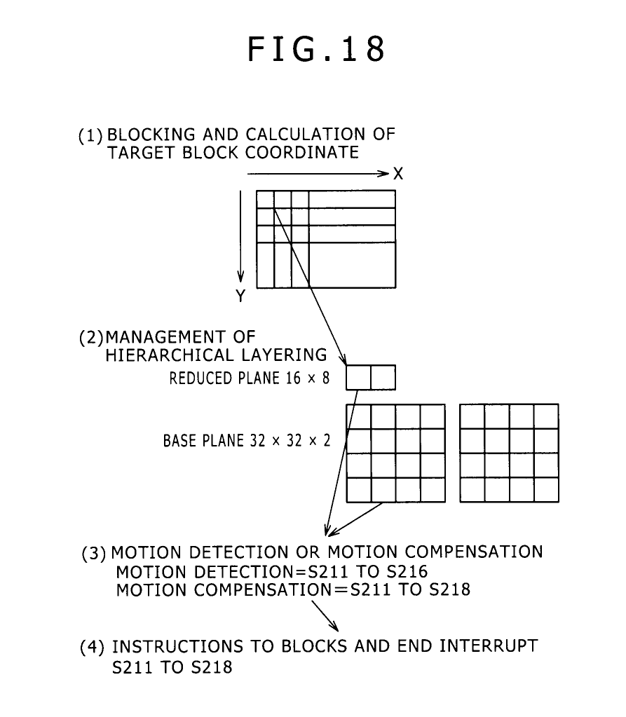

Target blocks and reference blocks transferred in accordance with the instructions from the real time control section 1652 are managed in a hierarchical state. In particular, as shown in FIG. 18, management of blocking of image data of one frame and hierarchical layering by setting a reduced plane and a base plane are carried out after target block coordinates are calculated. Then, motion detection or motion compensation is carried out based on data of the reduced plane and the base plane. In the case where only motion detection is carried out, the processes at steps S211 to S216 described hereinabove are carried out. However, in order to obtain a motion compensation image, the processes at steps S211 to 5218 described hereinabove are carried out.

Further, processing is executed in accordance with the flow described hereinabove with reference to FIG. 17 based on the instructions to the blocks and termination interrupt.

### <Example of the Rectangle Process>

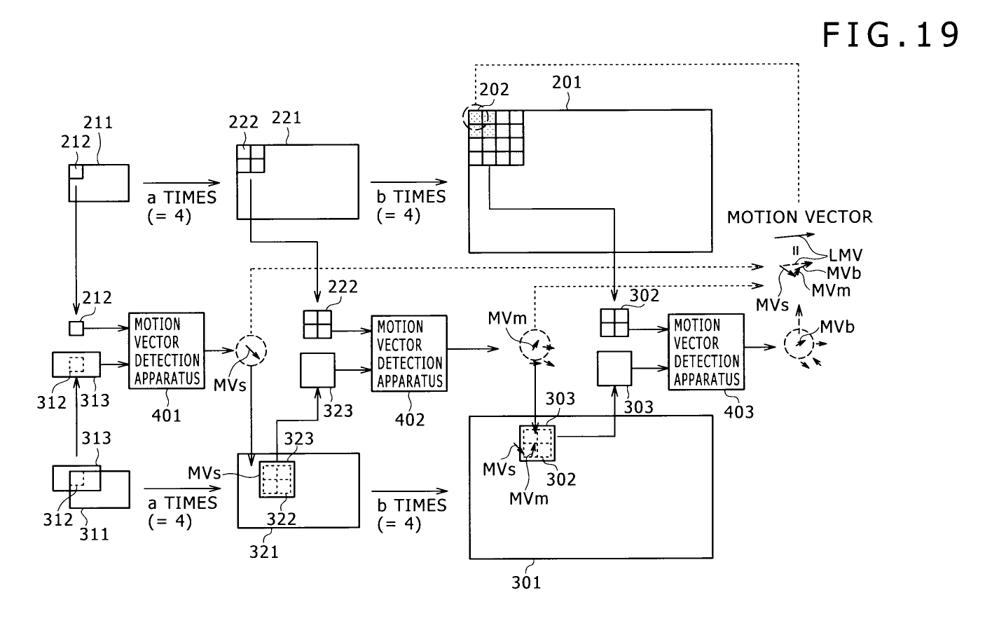

FIG. 19 illustrates hierarchical block matching by a rectangle process. Referring to FIG. 19, in the example illustrated, a base plane target frame 201 and a base plane reference frame 301 are reduced by a reduction rate 1/a·1/b, where a>1 and b>1, to produce a reduced plane target frame 211 and a reduced plane reference frame 311.

Further, the base plane target frame 201 and the base plane reference frame 301 are reduced to 1/b to produce an intermediate plane target frame 221 and an intermediate plane reference frame 321.

Although the reduction rate of a reduced plane or an intermediate plane to a base plane may be determined arbitrarily, it is preferably set within a range from 1/2 to 1/8, that is, from 1/4 to 1/64 in terms of the number of pixels. It is to be noted that, in the example of FIG. 19, the reduction rate of the reduced plane to the intermediate plane is 1/4, that is, a=4, and the reduction rate of the intermediate plane to the base plane is 1/4, that is, b=4.

Also upon production of a reduced plane or an intermediate plane, the method therefor may be determined arbitrarily. However, if a method of producing a reduced plane or an intermediate plane by merely sampling out pixels of an original image in response to the reduction rate is employed, then a reflected component is liable to appear, and consequently, the motion vector to be detected on the first hierarchical layer, that is, on the reduced plane, is liable to displace from a correct motion vector. Therefore, usually sub-sampling is carried out in response to the reduction rate after a low-pass filter having a cut-off frequency band in accordance with the reduction rate is applied to the original picture.

In the present example, a luminance average value including those pixels which disappear by sub-sampling in accordance with the rate is produced and used as a luminance value of a reduced plane pixel or an intermediate plane pixel. In particular, in the case of 1/a reduction, a luminance average value in a square region of a×a pixels is calculated, and this luminance average value is used as a luminance value of a reduced plane pixel or an intermediate plane pixel. In the case of the present method, even if an intermediate plane is produced first and then a reduced plane is produced from the intermediate plane, the same result as that obtained when a reduced plane is produced directly from an original image is obtained. Therefore, the present method is efficient.

It is to be noted that, when a reduced plane is to be produced, the reduction rate in the horizontal direction and the reduction rate in the vertical direction may be same as described above or may be different from each other.

After a reduced plane and an intermediate plane are produced in such a manner as described above, a reduced plane target block 212 is set on the reduced plane target frame 211 and a reduced plane search range 313 is set on the reduced plane reference frame 311 first.

Then, a motion vector detection apparatus 401 for a reduced plane carries out the block matching process described above with regard to a plurality of reduced plane reference blocks 312 in the reduced plane search range 313 to detect a reduced plane reference block position which exhibits a minimum SAD value. Then, a reduced plane motion vector MVs is detected based on the detection of the reduced plane reference block position.

In the present example, the motion vector detection apparatus 401 executes processing for a block of the size of the reduced plane target block 212, that is, of a number of pixels in the horizontal direction×a number of lines in the vertical direction, as a block matching processing unit.

After the calculation of the reduced plane motion vector MVs comes to an end, an intermediate plane target block 222 is set in an intermediate plane target frame 221 which is equal to the reduced plane target frame 211 multiplied by a.

In the example of FIG. 19, a motion vector detection apparatus 402 for an intermediate plane carries out a block matching process for a block of a size equal to the block matching processing unit in the motion vector detection apparatus 401 for a reduced plane as an intermediate plane target block. Here, the block of the same size is a block including an equal number of pixels and including an equal number of pixels in the horizontal direction×an equal number of lines in the vertical direction.

In the present example, since the reduced plane has a size of 1/a of that of the intermediate plane, a intermediate plane target blocks 222 are included in a region of the intermediate plane target frame corresponding to the reduced plane target block 212. Accordingly, all of the a intermediate plane target blocks 222 are set as a block matching processing object of the motion vector detection apparatus 402 for an intermediate plane.

Then, in the intermediate plane reference frame 321 having a size equal to a times that of the reduced plane reference frame 311, an intermediate plane search range 323 centered at the reduced plane motion vector MVs is set. A block matching process is carried out by the motion vector detection apparatus 402 with regard to a plurality of intermediate plane reference blocks 322 in the intermediate plane search range 323 and an intermediate plane reference block position which exhibits a minimum SAD value is detected to detect an intermediate plane motion vector MVm.

The motion vector detection apparatus 402 for an intermediate plane executes, for each of the a intermediate plane target blocks, a block matching process in a search range for the intermediate plane target block set in the intermediate plane search range 323. Consequently, detection of a motion vector is carried out with regard to the intermediate plane target blocks. Then, from among a plurality of motion vectors detected in this manner, a motion vector which exhibits a minimum SAD value is detected as a motion vector on the intermediate plane, that is, as the intermediate plane motion vector MVm.

After calculation of the reduced plane motion vector MVs comes to an end, a base plane target block 202 is set in the base plane target frame 201 which has a size equal to b times that of the intermediate plane target frame 221.

In the example of FIG. 19, also a motion vector detection apparatus 403 for a base plane carries out a block matching process for a block of a size equal to that of the motion vector detection apparatus 401 and 402 as a processing unit block. The size equal to that of the motion vector detection apparatus 401 and 402 is an [equal pixel number=an equal pixel number in the horizontal direction×an equal line number in the vertical direction].

Then, the intermediate plane motion vector MVm is obtained in a unit of a processing unit block as described hereinabove. Accordingly, the base plane target block 202 in the base plane target frame 201 which is an object of the motion vector detection apparatus 403 is set so as to include b blocks of a size equal to that of the reduced plane target block as indicated by slanting lines in FIG. 19.

Meanwhile, in the base plane reference frame 301 having a size equal to b times that of the intermediate plane reference frame 321, a base plane search range 303 centered at a composite vector of the reduced plane motion vector MVs and the intermediate plane motion vector MVm is set. The motion vector detection apparatus 403 carries out the block matching process described hereinabove for a plurality of base plane reference blocks 302 in the base plane search range 303, and detects a base plane reference block position which exhibits a minimum SAD value to detect a base plane motion vector MVb.

The reduced plane motion vector MVs and the intermediate plane motion vector MVm are obtained in a unit of a processing unit block of an equal size. Therefore, the base plane search range 303 set so as to be centered at the composite vector of the reduced plane motion vector MVs and the intermediate plane motion vector MVm is a region a little greater than a region which includes b base plane target blocks 202.

The motion vector detection apparatus 403 executes a block matching process within a search range regarding each of the base plane target blocks set in the base plane search range 303 with regard to the b base plane target blocks 202. The motion vector detection apparatus 403 thereby carries out detection of a motion vector with regard to each of the base plane target blocks. Then, from among the motion vectors detected in this manner, a motion vector which exhibits a minimum SAD value is detected as a motion vector on the base plane, that is, as the base plane motion vector MVb.

Then, a local motion vector LMV is detected as a composite vector of the reduced plane motion vector MVs, intermediate plane motion vector MVm and base plane motion vector MVb determined in such a manner as described above. The local motion vector LMV is a local motion vector regarding the base plane target block between the base plane target frame 201 and the base plane reference frame 301.

Such a hierarchical block matching process as described above is carried out successively for all regions of the target frame and the reference frame while the target block and the reference block are successively changed over. Consequently, all of a plurality of local motion vectors LMV of a plurality of target block units set in the target frame are calculated by the rectangle process.

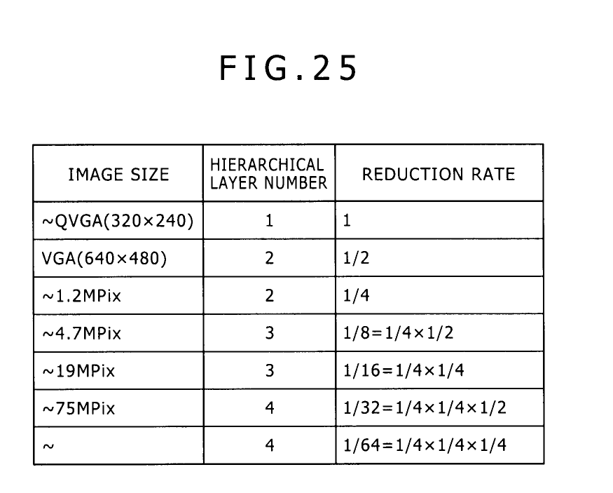

FIG. 25 illustrate an example of setting of a hierarchical layer number and a reduction rate of a reduced plane when a hierarchical block matching process is carried out in response to the image size in the case where the rectangle process is executed in the example of the present embodiment.

For example, in the case of image data wherein one frame is formed from data of a number of pixels up to 320 pixels×240 pixels, the block matching process is carried out in one hierarchical layer, in other words, without using a reduced plane.

In the case of image data wherein one frame is formed from data of a number of pixels of 640 pixels×480 pixels, the block matching process is carried out in two hierarchical layers, and 1/2 is set as the reduction rate.

In the case of image data wherein one frame is formed from data of a number of pixels up to 1.2M pixels, the block matching process is carried out in two hierarchical layers, and 1/4 is set as the reduction rate.

In the case of image data wherein one frame is formed from data of a number of pixels up to 4.7M pixels, the block matching process is carried out in three hierarchical layers, and 1/4 and 1/2 are set as the reduction rates.

In the case of image data wherein one frame is formed from data of a number of pixels up to 19M pixels, the block matching process is carried out in three hierarchical layers, and 1/4 and 1/4 are set as the reduction rates.

In the case of image data wherein one frame is formed from data of a number of pixels up to 75M pixels, the block matching process is carried out in four hierarchical layers, and 1/4, 1/4 and 1/2 are set as the reduction rates.

In the case of image data of a still greater size, the block matching process is carried out in four hierarchical layers, and 1/4, 1/4 and 1/4 are set as the reduction rates.

In the case of the rectangle process, change of such setting based on the image size as illustrated in FIG. 25 can be carried out readily, and favorable motion detection and motion compensation suitable for the size of an image to be picked up can be carried out. It is to be noted that the setting illustrated in FIG. 25 is an example, and the setting is not limited to the example.

### <Example of the Real Time Process>

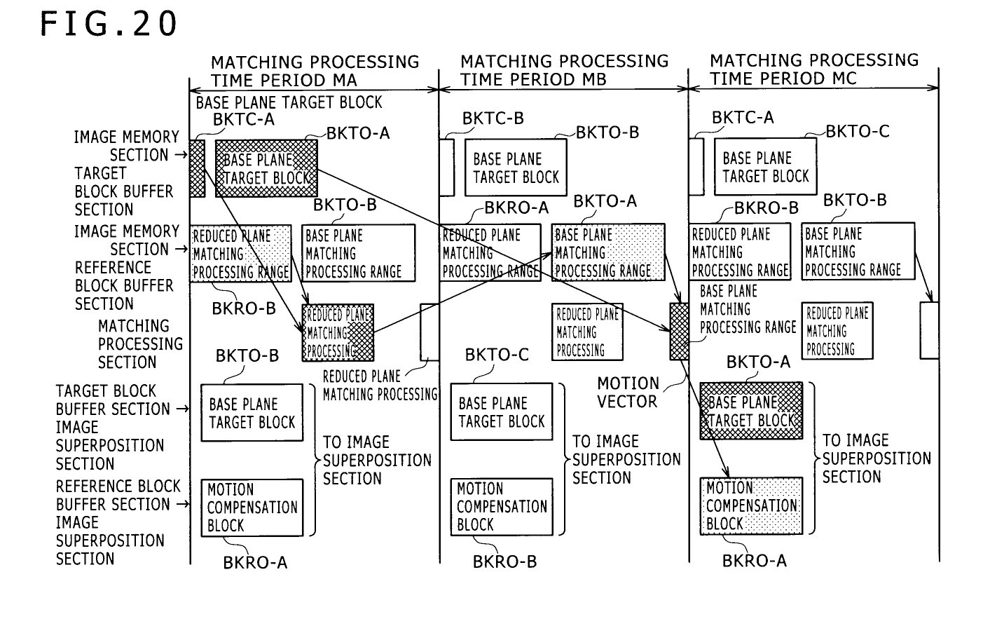

FIG. 20 illustrates execution of a real time process in a time series. Referring to FIG. 20, the axis of abscissa indicates lapse of time. The real time process illustrated in FIG. 20 is an example of a process of an image signal of a moving picture where image signals of the moving picture are supplied one by one for each frame.

In the example of FIG. 20, from among four banks of bank buffers BKTO-A to BKTO-D which retain target blocks in a base plane buffer section of the target block buffer section 161, at least three banks are used. Further, three processes of a reduced plane matching process, a base plane matching process and a motion compensation block transfer process are divided in the time direction so as to be pipelined over three matching processing time periods, that is, matching processing time periods for three target blocks.

It is assumed that, in the processing method illustrated in FIG. 20, the three bank buffers BKTO-A to BKTO-C from among the four bank buffers BKTO-A to BKTO-C provided in the base plane buffer section are used.

In the example illustrated, in the pipelining of the block matching process in the moving picture NR process, three matching processing time periods MA, MB and MC are set. Each of the three matching processing time periods MA, MB and MC includes all matching process contents regarding one target block, and the three matching processing time periods MA, MB and MC are matching processing time periods for three target blocks.

In particular, the processing contents in each of the matching processing time periods MA, MB and MC include all of the following processes. In particular, a reading in process of a reduced plane target block and a base plane target block from the image memory 40 is carried out. Then, reading in of a reduced plane matching process range and a base plane matching process range from the image memory 40 is carried out. Also a reduced plane matching process, a base plane matching process, and a transfer outputting process of a base plane target block and a motion compensation block to the image superposition section 17 are carried out. The signal processing contents quite same as each other are provided in the three matching processing time periods MA, MB and MC.

In the present example, for which one of target blocks the transfer outputting processes by the processes in the three matching processing time periods MA, MB and MC are carried out is controlled in the following manner.

In particular, in the present example, three processes of the reduced plane matching process, base plane matching process and motion compensation block transfer process regarding one target block are distributed to the three matching processing time periods MA, MB and MC and successively executed. Then, the matching processing time periods MA, MB and MC are repetitively executed as one unit.

For example, the reduced plane matching process regarding one certain target block TGB is carried out within the matching processing time period MA, and the base plane matching process regarding the target block TGB is carried out within the next matching processing time period MB. Then, the outputting transfer of the motion compensation block regarding the target block TGB is carried out within the further succeeding matching processing time period MC.

Then, while the reduced plane matching process regarding a certain target block is being carried out, reading out of the base plane matching processing range of the immediately preceding target block is carried out in parallel. Further, while reading out of the reduced plane matching processing range regarding the certain target block from the image memory 40 is being carried out, an outputting transfer process of the motion compensation block regarding the second preceding target block produced based on the final motion vector determined by the base plane matching process within the immediately preceding matching processing time period is carried out. By this, pipelining processing of the hierarchical block matching process is implemented. Processes indicated by slanting lines and meshing lines in FIG. 20 and connected to each other by an arrow mark are processes for image data of one frame. In particular, utilizing three matching processing time periods, a motion compensation block regarding a target block written in the second preceding matching processing time period MA and a base plane target block are transferred to the superposition section. However, in the example of FIG. 20, a flow for calculation of a motion vector is illustrated in regard to two cases including a case in which a motion vector is calculated from a result of a matching process on a reduced plane and used in a matching process on a base plane and another case in which a motion vector is calculated from a result of a matching process on a base plane and the motion compensation block is used.

### 4. Flow of an Outline of the Noise Reduction Process of a Picked Up Image

### <Upon Still Picture Image Pickup>

Flow charts of a noise reduction process by superposition of images upon still picture image pickup by the imaging apparatus of the present embodiment having the configuration described above are described with reference to FIGS. 21 and 22. Steps of the flow charts of FIGS. 21 and 22 are executed by the image superposition section 17 under the control of the system CPU 1 and the control section 165 of the motion detection and motion compensation section 16 which is controlled by the system CPU 1.

First, if the shutter button is pressed, then the imaging apparatus of the present embodiment carries out high speed image pickup of a plurality of images under the control of the system CPU 1. In the present example, picked up image data of M frames to be superposed upon still picture image pickup are fetched and stored into the image memory 40 at step S1. Here, M is an integer equal to or greater than 2.

Then at step S2, a reference frame is set to the Nth one in time of the M frames stored in the image memory 40. Here, N is an integer equal to or greater than 2 and a maximum value of N is M. In particular, the control section 165 sets an initial value for the value N to N=2. Then, at step S3, the control section 165 sets the first image frame as a target image or target frame and sets the N=2nd image as a reference image or reference frame.

Then at step S4, the control section 165 sets a target block in the target frame, and then at step S5, the motion detection and motion compensation section 16 reads the target block from an image memory section 4 into the target block buffer section 161. Further, at step S6, the motion detection and motion compensation section 16 reads pixel data in a matching processing range from the image memory 40 into the reference block buffer section 162.

Then at step S7, the control section 165 reads out the reference block within the search range from the reference block buffer section 162, and the matching processing section 163 carries out a hierarchical matching process. The processes are repeated with regard to all reference vectors in the search range, and a base plane motion vector of a high accuracy is outputted.

Thereafter, at step S8, the control section 165 reads out a motion compensation block compensated with by the detected motion vector from the reference block buffer section 162 in accordance with the base plane motion vector of the high accuracy detected in such a manner as described above. Then, the control section 165 sends the motion compensation block to the image superposition section 17 at the succeeding stage in synchronism with the target block at step S9.

Then, the image superposition section 17 carries out superposition of the target block and the motion compensation block and stores NR image data of the superposed block into the image memory section 4 under the control of the system CPU 1 at step S10. In other words, the image superposition section 17 outputs the NR image data of the superposed block to the image memory 40 so as to be written into the image memory 40.

Then at step S11, the control section 165 decides whether or not the block matching is completed for all of the target blocks in the target frame. If it is decided that the block matching process is not completed for all of the target blocks, then the processing returns to step S4, at which a next target block in the target frame is set, whereafter the processes at steps S4 to S11 are repeated.

On the other hand, if the control section 165 decides at step S11 that the block matching is completed for all of the target blocks in the target frame, then the processing advances to step S12. At step S12, the control section 165 decides whether or not the processing is completed for all reference frames to be superposed, that is, whether or not M=N.

If the decision of M=N is not made at step S12, then N is set to N+1, that is, N=N+1, at step S13. Then, the NR image produced by the superposition at step S10 is determined as a target image or target frame, and the N+1th image is determined as a reference image or reference frame at step S14. Thereafter, the processing returns to step S4 to repeat the processes at the steps beginning with step S4. In particular, in the case where M is greater than 3, an image obtained by the superposition in all target blocks is determined as a next target image and an image following the third image is determined as a reference frame, and then the processes described above are repeated for the newly determined target image and reference frame. This is repeated until the superposition for the Mth image is completed. Then, if M=N is decided at step S12, then this processing routine is ended.

### 5. Example of a Flow of the Hierarchical Block Matching Process

Flow charts of an example of operation of the hierarchical block matching process by the motion detection and motion compensation section 16 are illustrated in FIGS. 23 and 24.

It is to be noted that, although the following description of a flow of processing illustrated in FIGS. 23 and 24 partly overlaps with the description of the flow of the example of processing of the matching processing section 163 and the motion vector calculation section 164 described hereinabove, the following description is given in order to facilitate understandings of the operation of the present example.

First at step S71 in FIG. 23, the motion detection and motion compensation section 16 reads in a reduced plane of a target block, that is, a reduced plane target block, from the target block buffer section 161. Then at step S72, the motion detection and motion compensation section 16 sets an initial value for a reduced plane minimum SAD value as an initial value for a minimum SAD value 5 min retained in the motion vector calculation section 164. As the initial value for the reduced plane minimum SAD value 5 min, for example, a maximum value of the difference among pixels is set.

Then at step S73, the matching processing section 163 sets a reduced plane search range. Then, the matching processing section 163 sets a reduced plane reference vector (Vx/n, Vy/n: 1/n is a reduction rate) within the set reduced plane search range and sets a reduced plane reference block position for the calculation of a SAD value. Then at step S74, the matching processing section 163 reads in pixel data of the set reduced plane reference block from the reference block buffer section 162, and determines the sum total of absolute values of differences of the pixel data between the reduced plane target block and the reduced plane reference block, that is, a reduced plane SAD value. Then, the matching processing section 163 outputs the determined reduced plane SAD value to the motion vector calculation section 164 at step S75.

Then at step S76, the motion vector calculation section 164 compares the reduced plane SAD value Sin calculated by the matching processing section 163 and the reduced plane minimum SAD value 5 min retained therein with each other. Then, the motion vector calculation section 164 decides whether or not the calculated reduced plane SAD value Sin is smaller than the reduced plane minimum SAD value 5 min retained till then.

If it is decided at step S76 that the calculated reduced plane SAD value Sin is lower than the reduced plane minimum SAD value 5 min, then the processing advances to step S77, at which updating of the retained reduced plane minimum SAD value 5 min and position information of the same is carried out.

In particular, in the SAD value comparison process, a result of comparison that the calculated reduced plane SAD value Sin is lower than the reduced plane minimum SAD value 5 min is outputted. Consequently, the calculated reduced plane SAD value Sin and the position information, that is, a minimum image reference vector, are updated as information of the new reduced plane minimum SAD value 5 min.

From step S77, the processing advances to step S78. Further, if it is decided at step S76 that the calculated reduced plane SAD value Sin is equal to or greater than the reduced plane minimum SAD value 5 min, then the processing advances to step S78 without carrying out the updating process of the retained information at step S77.

At step S78, the matching processing section 163 decides whether or not the matching process is completed at all of the positions or the reduced reference blocks within the reduced plane search range, that is, for all reduced plane reference vectors. If it is decided that a reduced plane reference block which is not processed as yet remains in the reduced plane search range, then the processing returns to step S73 to repeat the processes at the steps beginning with step S73.

On the other hand, if the matching processing section 163 decides at step S78 that the matching process is completed at all of the positions of the reduced plane reference blocks within the reduced plane search range, that is, for all reduced plane reference vectors, then the following processes are carried out at step S79. In particular, the matching processing section 163 receives the position information of the reduced plane minimum SAD value 5 min, that is, the reduced plane motion vector. Then, the matching processing section 163 sets a base plane target block at a position centered at a position coordinate pointed to in the base plane target frame by a vector obtained by multiplying the received reduced plane motion vector by a reciprocal number of the minimum rate, that is, by n. Further, the matching processing section 163 sets a base plane search range as a comparatively small range centered at the position coordinate pointed to by the vector multiplied by n to the base plane target frame. Then at step S80, the matching processing section 163 reads in pixel data of the base plane target block from the target block buffer section 161.

Referring now to FIG. 20, at step S81, the matching processing section 163 sets the initial value of the minimum SAD value 5 min retained in the motion vector calculation section 164 as an initial value for the base plane minimum SAD value. As the initial value for the base plane minimum SAD value 5 min, for example, a maximum value of the difference between the pixels is set.

Then at step S82, the matching processing section 163 sets a base plane reference vector (Vx, Vy) in the base plane search range set at step S79 and sets a base plane reference block position for the calculation of the SAD value. Then at step S83, the matching processing section 163 reads in pixel data of the set base plane reference block from the reference block buffer section 162. Then at step S84, the matching processing section 163 determines the sum total of absolute values of the differences of the pixel data between the base plane target block and the base plane reference block, that is, the base plane SAD value, and signals the determined base plane SAD value to the motion vector calculation section 164.

Then at step S85, the motion vector calculation section 164 compares the base plane SAD value Sin calculated by the matching processing section 163 and the retained base plane minimum SAD value 5 min with each other. Then, the motion vector calculation section 164 decides based on the comparison whether or not the calculated base plane SAD value Sin is lower than the base plane minimum SAD value 5 min retained till then.

If it is decided at step S85 that the calculated base plane SAD value Sin is smaller than the base plane minimum SAD value 5 min, then the processing advances to step S86, at which updating of the retained base plane minimum SAD value 5 min and the position information of the same is carried out.

In particular, information of a result of the comparison that the calculated base plane SAD value Sin is smaller than the base plane minimum SAD value 5 min is outputted. Consequently, the calculated base plane SAD value Sin and the position information of the same, that is, the reference vector, are determined as new information of the base plane minimum SAD value 5 min and used for the updating.

From step S86, the processing advances to step S87. Meanwhile, when it is decided at step S85 that the calculated base plane SAD value Sin is equal to or higher than the base plane minimum SAD value 5 min, the processing advances to step S87 without carrying out the updating process of the retained information at step S86.

At step S87, the matching processing section 163 decides whether or not the matching process is completed at all of the positions of the base plane reference blocks within the base plane search range, that is, for all base plane reference vectors. If the decision proves that a base plane reference block which has not been processed as yet remains in the base plane search range, then the processing returns to step S82 to repeat the processes at the steps beginning with step S82.

On the other hand, if the matching processing section 163 decides at step S87 that the matching process is completed at all positions of the base plane reference blocks in the base plane search range, that is, for all reference image reference vectors, then the matching processing section 163 carries out the following process at step S88. In particular, the matching processing section 163 receives the position information of the base plane minimum SAD value 5 min, that is, the base plane motion vector, and retains the base plane SAD value.

The block matching process of the present example regarding one reference frame ends therewith.

It is to be noted that, while, in the embodiment described hereinabove, an image processing apparatus according to the disclosed technology is applied to an imaging apparatus, the disclosed technology can be applied not only to the imaging apparatus but also to various image processing apparatus.

Further, while, in the embodiment described above, the disclosed technology is applied to a case in which a noise reduction process based on superposition of images is carried out using a block matching technique, the disclosed technology is not limited to the specific case. In other words, the disclosed technology can be applied to all image processing apparatus wherein image data written in an image memory are read out and used for motion detection or the like.

The present technology contains subject matter related to that disclosed in Japanese Priority Patent Application JP 2011-000802 filed in the Japan Patent Office on Jan. 5, 2011, the entire content of which is hereby incorporated by reference.

While a preferred embodiment of the disclosed technology has been described using specific terms, such description is for illustrative purposes only, and it is to be understood that changes and variations may be made without departing from the spirit or scope of the following claims.

What is claimed is:

1. An image processing apparatus, comprising:
an image processing section adapted to calculate a motion vector of an image signal between a plurality of frames;
a first control section adapted to programmably control said image processing section to execute motion detection; and
a second control section adapted to control said image processing section in a processing state determined in advance to execute motion detection.

2. The image processing apparatus according to claim 1, wherein said second control section is configured from hardware.

3. The image processing apparatus according to claim 2, wherein
said first control section operates to process the image signal where the image signal is a signal of a still picture; and
said second control section operates to process the image signal where the image signal is a signal of a moving picture.

4. An image processing method, comprising:
an image process of calculating a motion vector of an image signal between a plurality of frames;
a first controlling process of programmably controlling execution of the image process to execute motion detection; and
a second controlling process of controlling the image process in a processing state determined in advance to execute motion detection.

5. The image processing method according to claim 4, wherein the second controlling process is executed by hardware.

6. The image processing method according to claim 5, wherein
the first controlling process is executed to process the image signal where the image signal is a signal of a still picture; and
the second controlling process is executed to process the image signal where the image signal is a signal of a moving picture.
